(19) United States
(12) Patent Application Publication
(10) Pub. No.: US 2026/0029897 A1
(43) Pub. Date: Jan. 29, 2026

(54) INTERFACE DISPLAY METHOD AND APPARATUS, COMPUTER DEVICE AND STORAGE MEDIUM

(71) Applicant: HUIZHOU TCL MOBILE COMMUNICATION CO., LTD., Huizhou, Guangdong (CN)

(72) Inventors: Hui ZHANG, Huizhou, Guangdong (CN); Tang DING, Huizhou, Guangdong (CN)

(73) Assignee: HUIZHOU TCL MOBILE COMMUNICATION CO., LTD., Huizhou, Guangdong (CN)

(21) Appl. No.: 18/995,157

(22) PCT Filed: Jun. 13, 2023
(86) PCT No.: PCT/CN2023/099996

§ 371 Date: Jan. 16, 2025

(30) Foreign Application Priority Data
Aug. 9, 2022 (CN) 202210952843.6

(51) Int. Cl. G06F 3/0484; G06T 3/40; G06T 3/60

(52) U.S. Cl. CPC G06F 3/0484; G06T 3/40; G06T 3/60; G06T 2200/24

(57) ABSTRACT

An interface display method and apparatus, a computer device, and a storage medium are provided. The method includes: determining a target view interface; acquiring an auxiliary view interface including a hollow area; performing a superposition processing on an initial view interface, a target view interface, and an auxiliary view interface to obtain a view interface sequence; and performing a transformation processing to present a display based on the hollow area.

This application claims priority to Chinese Patent Applications No. 202210952843.6, filed on Aug. 9, 2022 and entitled “INTERFACE DISPLAY METHOD AND APPARATUS, COMPUTER DEVICE AND STORAGE MEDIUM”. The entire disclosures of the above application are incorporated herein by reference.

### TECHNICAL FIELD

This application relates to the field of computer technologies, and specifically to an interface display method and apparatus, a computer device, and a storage medium.

### BACKGROUND TECHNOLOGY

During an interface display process on a terminal device, it is possible to switch from displaying an initial view interface to a target view interface to achieve device switching and provide users with a better viewing experience. The device switching is commonly used in practical scenarios, such as switching a device between different interface orientations or adapting to changes in interface arrangement, among others.

### Technical Problem

During the research and practice of related technologies, inventors of the present application discovered that there are many problems that affect a display dynamic effect and display efficiency in an existing interface switching display method. For example, in order to present a dynamic transition from an initial view interface to a target view interface during a process of switching between displaying different interfaces, so that users can actually perceive the switching display of a view interface, it is often necessary to design and control a large number of layers. Moreover, when presenting dynamic effects of the device switching, corresponding time and computing resources are also needed to render these layers, which makes the process of device switching time-consuming and consumes a lot of computing resources, resulting in an interface display efficiency and the display dynamic effect of the user experience need to be improved.

### SUMMARY OF INVENTION

Embodiments of the present application propose an interface display method and apparatus, a computer device, and a storage medium, which can improve a display dynamic effect of an interface and improve a display efficiency of the interface during a process of switching to display different interfaces.

An embodiment of the present application provides an interface display method, including:
in response to a display switching instruction for a currently displayed initial view interface, determining a target view interface indicated by the display switching instruction.
acquiring an auxiliary view interface displayed on an interface, where the auxiliary view interface includes a hollow area.
performing a superposition processing on the initial view interface, the target view interface, and the auxiliary view interface to obtain a view interface sequence in which the auxiliary view interface is placed on an upper layer.
performing a transformation processing on the view interface sequence to present a display from the initial view interface to the target view interface based on the hollow area.

Correspondingly, an embodiment of the present application also provides an interface display apparatus, including:
a determination unit configured to determine a target view interface indicated by a display switching instruction in response to the display switching instruction for a currently displayed initial view interface.
an acquisition unit configured to acquire an auxiliary view interface displayed on an interface, where the auxiliary view interface includes a hollow area.
a superposition unit configured to perform a superposition processing on the initial view interface, the target view interface, and the auxiliary view interface to obtain a view interface sequence in which the auxiliary view interface is placed on an upper layer.
a transformation unit configured to perform a transformation processing on the view interface sequence to present a display from the initial view interface to the target view interface based on the hollow area.

In one embodiment, the determination unit includes:
an orientation determination subunit configured to determine a target interface orientation indicated by a screen switching instruction if the screen switching instruction is detected during a process of displaying the initial view interface corresponding to an initial interface orientation.
an interface determination subunit configured to determine the target view interface indicated by the display switching instruction according to the initial view interface and the target interface orientation.

In one embodiment, the acquisition unit includes:
an area information determination subunit configured to determine area size information and area arrangement information of the hollow area, where the area arrangement information is configured to describe an area arrangement of the hollow area in the auxiliary view interface.
an area division subunit configured to divide the hollow area in a view interface of a target size according to the area size information and the area arrangement information.
an interface drawing subunit configured to draw the divided view interface to acquire the auxiliary view interface displayed on the interface.

In one embodiment, the area division subunit is configured to:
determine a target distance feature of the hollow area according to a target interface orientation indicated by the display switching instruction, where the target distance feature represents a distance between the hollow area and a terminal display area; analyze the target distance feature to determine a target size of the view interface of the hollow area to be divided; divide the hollow area in the view interface corresponding to the target size according to the area size information and the area arrangement information.

In one embodiment, the interface drawing subunit is configured to:
determine a mask area in the view interface of the target size according to a division result; determine drawing parameter information of the mask area; draw the divided view interface according to the drawing parameter information.

In one embodiment, the superposition unit includes:
an area determination subunit configured to respectively determine target focus areas of the initial view interface, the target view interface, and the auxiliary view interface.
a superposition processing subunit configured to perform the superposition processing on the initial view interface, the target view interface, and the auxiliary view interface according to the determined target focus areas.

In one embodiment, the target view interface includes at least one interface element; the area determination subunit is configured to:
determine a focused target interface element from interface elements of the target view interface; determine the target focus area of the target view interface according to element arrangement information of the target interface element in the target view interface.

In one embodiment, the transformation unit includes:
an interface information determination subunit configured to determine size adjustment information of a view interface in the view interface sequence.
a size adjustment subunit configured to perform a size adjustment transformation processing on the view interface in the view interface sequence according to the size adjustment information to present a size adjustment of a view interface under the auxiliary view interface during a display process from the initial view interface to the target view interface based on the hollow area of the auxiliary view interface.

In one embodiment, the size adjustment information indicates that the size adjustment is achieved by performing a scaling transformation on the view interface under the auxiliary view interface; the size adjustment subunit is configured to:
acquire area size information of the hollow area of the auxiliary view interface; determine a scaling threshold for the view interface under the auxiliary view interface according to the area size information; perform the size adjustment transformation processing on the view interface under the auxiliary view interface in the view interface sequence based on the size adjustment information and the scaling threshold.

In one embodiment, the view interface under the auxiliary view interface in the view interface sequence includes at least one interface element; the size adjustment subunit is specifically configured to:
determine a focused target interface element of a scaling transformation processing from interface elements of the view interface; determine a scaling center area of performing the scaling transformation on the view interface according to element arrangement information of the target interface element in the view interface; perform the scaling transformation processing on the view interface based on the scaling center area.

In one embodiment, the view interface sequence includes the auxiliary view interface, and the size adjustment information indicates that the size adjustment is achieved by performing a shape transformation on the auxiliary view interface; the size adjustment subunit is configured to:
analyze the size adjustment information to obtain an initial shape and a target shape of the auxiliary view interface; in the display process from the initial view interface to the target view interface, acquire current display progress information, and transform the auxiliary view interface from the initial shape to the target shape according to the display progress information, so as to perform a shape transformation processing on the auxiliary view interface.

In one embodiment, the transformation unit includes:
an orientation determination subunit configured to determine a rotation orientation of each view interface in the view interface sequence according to a target interface orientation indicated by the display switching instruction.
a rotation transformation subunit configured to perform a rotation transformation processing on each view interface in the view interface sequence according to the rotation orientation to present a rotation transformation of a view interface under the auxiliary view interface in a display process from the initial view interface to the target view interface based on the hollow area of the auxiliary view interface.

In one embodiment, the transformation unit includes:
a property adjustment subunit configured to acquire current display progress information in a display process from the initial view interface to the target view interface, and adjust an interface property of a view interface in the view interface sequence according to the display progress information, so as to perform the transformation processing on the view interface sequence.

Correspondingly, an embodiment of the present application also provides a computer device, including a memory and a processor; the memory stores a computer program, and the processor is configured to run the computer program in the memory to execute any interface display method provided by the embodiments of the present application.

Correspondingly, an embodiment of the present application also provides a computer-readable storage medium, the computer-readable storage medium is configured to store a computer program, and the computer program is loaded by a processor to execute any interface display method provided by the embodiments of the present application.

Correspondingly, an embodiment of the present application also provides a computer program product, including a computer program/instruction. When the computer program/instruction is executed by a processor, steps of the interface display method shown in the embodiments of the present application are implemented.

### Beneficial Effects

The embodiment of the present application can, in response to the display switching instruction for the currently displayed initial view interface, determine the target view interface indicated by the display switching instruction; acquire the auxiliary view interface displayed on an interface, where the auxiliary view interface includes a hollow area; perform the superposition processing on the initial view interface, the target view interface, and the auxiliary view interface to obtain the view interface sequence in which the auxiliary view interface is placed on the upper layer; and perform the transformation processing on the view interface sequence to present the display from the initial view interface to the target view interface based on the hollow area.

This solution can, during a device switching process from displaying the initial view interface to displaying the target view interface, present a dynamic transition from the initial view interface to the target view interface through the auxiliary view interface with the hollow area, allowing the user to truly perceive the switch display of the view interface. Furthermore, since the device switching process only involves the initial view interface, the target view interface, and the auxiliary view interface, this solution can avoid the time consumption and computational resource consumption caused by the larger number of layers involved, thereby improving the dynamic display effect of the interface and enhancing the display efficiency. Additionally, because the solution acquires the auxiliary view interface before performing transformation processing on the view interface sequence to present an animation effect of the device switching, it allows the solution to pre-draw the auxiliary view interface required for the device switching before the animation of the device switching starts. This can reduce a system's computational burden during the animation process of the device switching, ensuring good drawing performance during the animation process of the device switching and avoiding issues such as drawing timeouts and animation stuttering caused by excessive drawing tasks, thus further improving the dynamic display effect of the interface and enhancing the display efficiency of the interface.

### BRIEF DESCRIPTION OF THE DRAWINGS

To describe the technical solutions in the embodiments of the present application clearly, the following briefly describes the accompanying drawings required for illustrating the embodiments of the present application. Apparently, the accompanying drawings described in the following description illustrate only some embodiments of the present application, and a person skilled in the art may derive other accompanying drawings based on these accompanying drawings without creative efforts.

FIG. 1 is a schematic diagram of a scenario of an interface display method provided by an embodiment of the present application.

FIG. 2 is a flowchart of an interface display method provided by an embodiment of the present application.

FIG. 3 is a schematic diagram of an application scenario of an interface display method provided by an embodiment of the present application.

FIG. 4 is another schematic diagram of an application scenario of an interface display method provided by an embodiment of the present application.

FIG. 5 is another schematic diagram of an application scenario of an interface display method provided by an embodiment of the present application.

FIG. 6 is another schematic diagram of an application scenario of an interface display method provided by an embodiment of the present application.

FIG. 7 is a schematic diagram of a device switching in an interface display method provided by an embodiment of the present application.

FIG. 8 is a schematic diagram of an auxiliary view interface in an interface display method provided by an embodiment of the present application.

FIG. 9 is another schematic diagram of an auxiliary view interface in an interface display method provided by an embodiment of the present application.

FIG. 10 is another schematic diagram of a device switching in an interface display method provided by an embodiment of the present application.

FIG. 11 is a schematic diagram of a view interface in an interface display method provided by an embodiment of the present application.

FIG. 12 is a schematic diagram of a view interface superimposition in an interface display method provided by an embodiment of the present application.

FIG. 13 is another schematic diagram of a view interface superimposition in an interface display method provided by an embodiment of the present application.

FIG. 14 is another schematic diagram of a view interface superimposition in an interface display method provided by an embodiment of the present application.

FIG. 15 is another schematic diagram of a view interface superimposition in an interface display method provided by an embodiment of the present application.

FIG. 16 is another schematic diagram of a device switching in an interface display method provided by an embodiment of the present application.

FIG. 17 is another schematic diagram of a view interface in an interface display method provided by an embodiment of the present application.

FIG. 18 is another schematic diagram of a device switching in an interface display method provided by an embodiment of the present application.

FIG. 19 is another flowchart of an interface display method provided by an embodiment of the present application.

FIG. 20 is another schematic diagram of a view interface superimposition in an interface display method provided by an embodiment of the present application.

FIG. 21 is a schematic diagram of a display process of an interface display method provided by an embodiment of the present application.

FIG. 22 is a schematic diagram of a module interaction in an interface display method provided by an embodiment of the present application.

FIG. 23 is a schematic diagram of a structure of an interface display apparatus provided by an embodiment of the present application.

FIG. 24 is a schematic diagram of a structure of a computer device provided by an embodiment of the present application.

### DETAILED DESCRIPTION OF THE EMBODIMENTS

The following describes the technical solutions in the embodiments of the present application clearly and completely with reference to the accompanying drawings in the embodiments of the present application. However, the described embodiments are merely a part rather than all of the embodiments of the present application. All other embodiments obtained by a person skilled in the art based on the embodiments in the present application without creative efforts shall fall within the protection scope of the present application.

An embodiment of the present application proposes an interface display method, which can be executed by an interface display apparatus, and the interface display apparatus can be integrated in a computer device. The computer device may include a terminal. The interface display method can be executed by the terminal, or by both a server and the terminal.

The terminal can be a personal computer, tablet, laptop, desktop computer, smart TV, smartphone, smart speaker, smart watch, VR/AR device, in-vehicle terminal, smart home device, wearable electronic device, etc., but is not limited to these. The terminal and the server can be connected directly or indirectly through wired or wireless communication, and no limitations are imposed in this application.

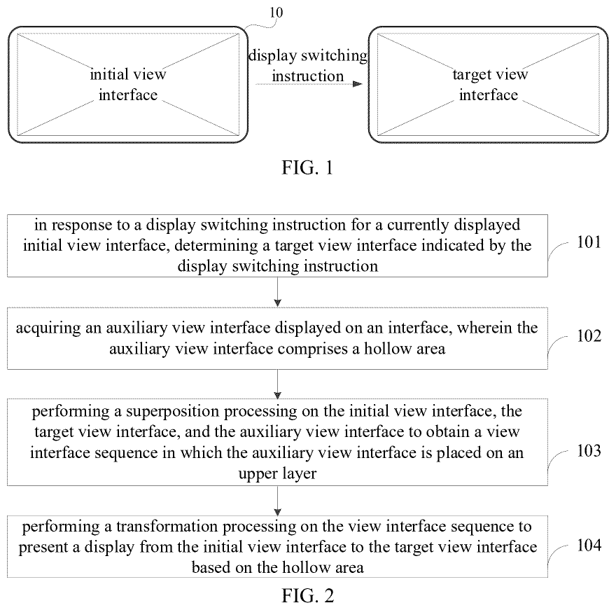

In one embodiment, as shown in FIG. 1, an interface display apparatus can be integrated on a computer device such as a terminal to implement an interface display method proposed in the embodiment of the present application. As an example, the embodiments of this application can take a computer device as a terminal to introduce the interface display method.

With reference to FIG. 1, a terminal 10 can respond to a display switching instruction for a currently displayed initial view interface, determine a target view interface indicated by the display switching instruction; acquire an auxiliary view interface displayed on an interface, where the auxiliary view interface includes a hollow area; perform a superposition processing on the initial view interface, the target view interface, and the auxiliary view interface to obtain a view interface sequence in which the auxiliary view interface is placed on an upper layer; and perform a transformation processing on the view interface sequence to present a display from the initial view interface to the target view interface based on the hollow area.

Detailed descriptions are provided below. It should be noted that the order of description of following embodiments is not intended to limit the preferred order of the embodiments.

It can be understood that in a specific implementation of this application, related data such as user information is involved. When the above embodiments of this application are applied to specific products or technologies, user permission or consent needs to be obtained, and collection, use, and processing of relevant data need to comply with relevant laws, regulations, and standards of relevant countries and regions.

The interface display method provided by the embodiments of the present application can be executed by the terminal, or jointly executed by the server and the terminal. The embodiments of the present application take the interface display method executed by the terminal as an example for explanation.

As shown in FIG. 2, a specific process of an interface display method can be as follows:
101. In response to a display switching instruction for a currently displayed initial view interface, determining a target view interface indicated by the display switching instruction.

The view interface refers to an interface displayed by a terminal. For example, the view interface may be an interface for displaying visual elements. For example, the visual elements may include visual patterns, visual texts, and the like.

The display switching instruction may be an instruction for switching from displaying the initial view interface to displaying the target view interface. Specifically, in the present application, the display switching instruction may be configured to implement a device switching from the initial view interface to the target view interface. Therefore, correspondingly, the initial view interface is a view interface before the device switching, and the target view interface is a view interface after the device switching.

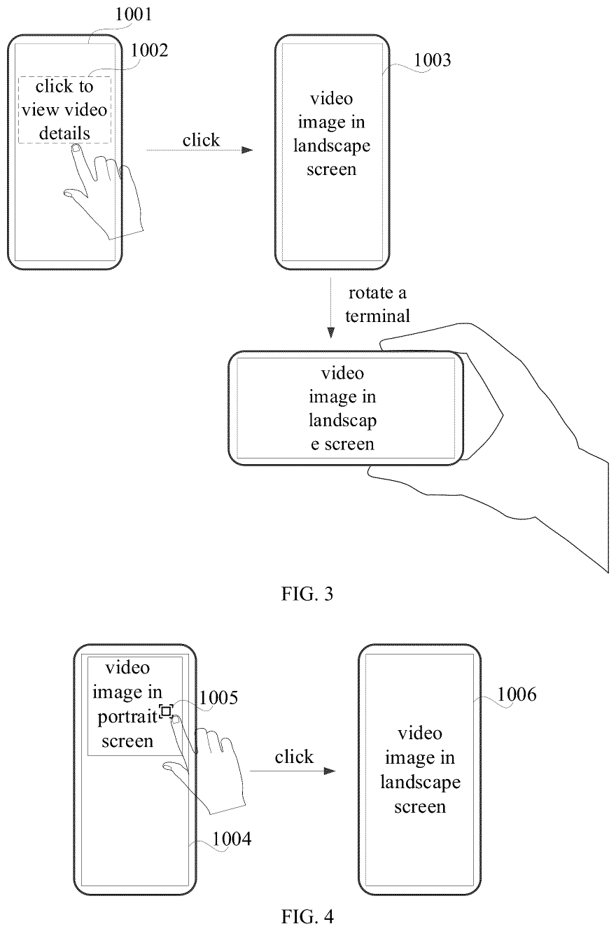

In one embodiment, the initial view interface and the target view interface in the present application may also be different view interfaces formed by completely different visual elements under different interface arrangement settings. For example, the initial view interface and the target view interface may be different view interfaces formed by different but related visual elements under different interface arrangement settings. As an example, referring to an application scenario shown in FIG. 3, the initial view interface may be an interface as shown in 1001. For example, the interface may specifically be a news display interface mainly composed of text and pictures, which may include a jump control element as shown in 1002. When a terminal detects that the jump control element is triggered, the terminal may jump to the target view interface as shown in 1003. The target view interface may display a video image in a landscape screen. In actual applications, the user may turn the terminal to a landscape screen state to better watch the video image displayed in the target view interface as shown in 1003. It can be seen that in this example, the display switching instruction may specifically be an instruction generated in response to a trigger operation for the jump control element, and the visual elements in the initial view interface and the target view interface are not the same, but the visual elements in the two view interfaces are related.

As another example, referring to an application scenario shown in FIG. 4, the initial view interface may be an interface as shown in 1004. For example, the interface may specifically be a video playback page in a portrait screen state, in which a video image played in the portrait screen is displayed. The video image may include a full-screen control element shown in 1005. When the terminal detects that the full-screen control element is triggered, the terminal may jump to the target view interface shown in 1006, in which the video image in the landscape screen may be displayed. In actual application, the user may turn the terminal to the landscape screen state to better view the video image displayed in the target view interface shown in 1003. It can be seen that in this example, the display switching instruction may specifically be an instruction generated in response to the trigger operation for the full-screen control element. The visual elements in the initial view interface and the target view interface are not the same, but the visual elements in the two view interfaces are related.

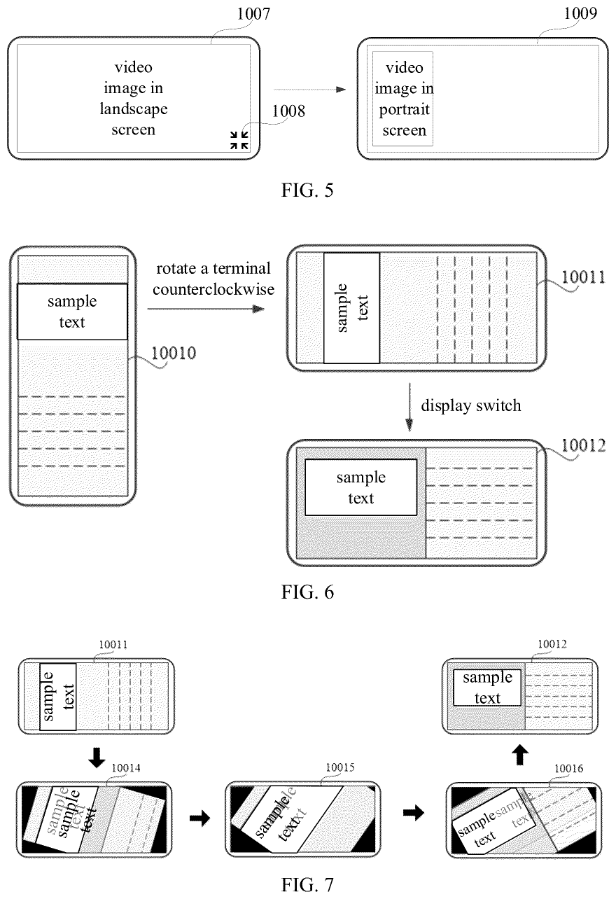

As another example, similarly, referring to an application scenario shown in FIG. 5, the initial view interface may be an interface as shown in 1007, for example, the interface may specifically be a video playback page in the landscape screen state, in which a video image played in the landscape screen is displayed, and the video image may include a cancel full-screen control element shown in 1008. When the terminal detects that the cancel full-screen control element is triggered, the terminal may jump to the target view interface shown in 1009, in which the video image in the portrait screen may be displayed. In actual applications, the user may turn the terminal to the portrait screen state to better view the video image displayed in the target view interface shown in 1009. It can be seen that in this example, the display switching instruction may specifically be an instruction generated in response to the trigger operation for the cancel full-screen control element, and the visual elements in the initial view interface and the target view interface are not the same, but the visual elements in the two view interfaces are related.

In one embodiment, the initial view interface and the target view interface in the present application may be different view interfaces formed by all or part of the same visual elements to adapt to different interface arrangement settings. For example, when the terminal displays the initial view interface, if a display switching instruction triggered by a screen switching operation is detected, the target view interface indicated by the display switching instruction is the view interface of the initial view interface under an interface orientation indicated by the screen switching instruction.

The interface orientation can be configured to indicate an orientation of the view interface that the user sees. For example, taking a mobile terminal as an example, the interface orientation can include an orientation corresponding to the view interface displayed in the portrait screen and an orientation corresponding to the view interface displayed in the landscape screen. For another example, in order to facilitate distinction, the terminal including a display screen and a main screen button below the display screen can be used as an example to illustrate the interface orientation. Specifically, the interface orientation may include: an interface orientation 1—the portrait screen, a corresponding orientation when the main screen button is located below the screen; an interface orientation 2—the portrait screen, a corresponding orientation when the main screen button is located above the screen; an interface orientation 3—the landscape screen, a corresponding orientation when the main screen button is located on a right side of the screen; an interface orientation 4—the landscape screen, a corresponding orientation when the main screen button is located on a left side of the screen. It is worth noting that the main screen button here is only used as an example to distinguish different interface orientations. If the aforementioned four interface orientations are used in the subsequent text, they are only intended to refer to the corresponding interface orientations, rather than to limit constituent modules of the terminal, that is, this application does not limit the constituent modules of the terminal.

As an example, referring to an application scenario shown in FIG. 6, the terminal can be taken as an example of switching from the portrait screen to the landscape screen. Specifically, in a process of the terminal displaying the exemplary view interface shown in 10010 in the portrait screen, if the terminal is rotated counterclockwise, the terminal can display the initial view interface shown in 10011 in the landscape screen state. Further, the terminal can display the target view interface shown in 10012 in response to the display switching instruction triggered by the screen rotation operation. It can be seen that in this example, the display switching instruction can specifically be an instruction triggered by the screen rotation operation, and the initial view interface and the target view interface can be different view interfaces formed by all or part of the same visual element to adapt to the interface arrangement settings corresponding to different interface orientations.

In one embodiment, it is considered that in the display process from the initial view interface to the target view interface, the display of the view interface under different interface orientations may be involved, for example, the display switching from the landscape screen to the portrait screen, or the display switching from interface orientation 2 to interface orientation 4, etc. In addition, it is also considered that the visual element in the initial view interface and the visual element in the target view interface may have multiple similarities, for example, the initial view interface and the target view interface may be different view interfaces formed by completely different visual elements under different interface arrangement settings, or the initial view interface and the target view interface may be different view interfaces formed by all or part of the same visual elements to adapt to different interface arrangement settings. Therefore, the instruction for displaying the view interface across the interface orientation can be determined as a screen switching instruction, and the target view interface indicated by the device switching instruction can be determined by combining the initial view interface and the target interface orientation indicated by the screen switching instruction. Specifically, the step of “determining the target view interface indicated by the display switching instruction in response to the display switching instruction for the currently displayed initial view interface” can include:
during a process of displaying the initial view interface corresponding to an initial interface orientation, if a screen switching instruction is detected, determining a target interface orientation indicated by the screen switching instruction.
determining the target view interface indicated by the display switching instruction according to the initial view interface and the target interface orientation.

The screen switching instruction is an instruction for instructing the view interface to be displayed across the interface orientation. It is worth noting that there are many ways to generate the screen switching instruction. For example, if a screen rotation operation is detected on the terminal (such as the user rotating the terminal), a screen switching instruction can be generated. For another example, it can be an instruction triggered and generated by an instruction indicating display across interface orientations (such as a full screen instruction of the video image, an exit full screen instruction of the video image, a link jump instruction, etc.) That is, the present application does not limit the screen switching instruction to be generated only by physically rotating the terminal device.

The target interface orientation indicated by the screen switching instruction refers to the interface orientation corresponding to the target view interface in the application scenario of switching from displaying the initial view interface to displaying the target view interface. For example, in the examples of FIG. 3, FIG. 4, and FIG. 6, the target interface orientation is the landscape screen display orientation of the video image; and in the example shown in FIG. 5, the target interface orientation is the portrait screen display orientation of the video image.

Since there may be a variety of ways to generate a screen switching instruction, there may also be a variety of corresponding ways to determine the target interface orientation indicated by the screen switching instruction. For example, a sensor may be configured to detect a screen switching operation on a terminal (such as a user switching the terminal), and generate a screen switching instruction. Then, the target interface orientation indicated by the screen switching instruction may be determined based on relevant detection data of the sensor. For another example, a screen switching instruction may be generated by triggering relevant instructions indicating display across interface orientations (such as a full-screen instruction for a video image, an exit full-screen instruction for a video image, a link jump instruction, etc.). Then, the interface orientation indicated by the relevant instruction may be determined as the target interface orientation indicated by the screen switching instruction, and so on.

Furthermore, the target view interface indicated by the display switching instruction can be determined according to the initial view interface and the target interface orientation. Specifically, the interface element displayed in the target view interface and the interface arrangement setting corresponding to the target view interface can be determined according to the initial view interface, and then the target view interface indicated by the display switching instruction can be determined by displaying the interface element according to the interface arrangement setting.

As an example, refer to the application scenario shown in FIG. 3, in which the initial view interface may be an interface as shown in 1001, for example, the interface may specifically be a news display interface mainly composed of pictures and texts. The jump control element shown in 1002 may be included. When the terminal detects that the jump control element is triggered, the terminal may determine the interface element to be displayed in the target view interface, that is, the interface element for playing the video image, and the interface arrangement setting of the target view interface under the target interface orientation indicated by the display switching instruction. For example, in the example of FIG. 3, the interface arrangement setting may specifically be a related setting for presenting the interface element in the landscape screen orientation. Furthermore, the terminal may display the interface element to be displayed of the target view interface according to the interface arrangement setting, thereby determining the target view interface indicated by the display switching instruction.

As another example, referring to the application scenario shown in FIG. 6, the initial view interface may be an interface as shown in 10011, for example, the interface may be obtained by rotating the terminal counterclockwise in the process of displaying the exemplary view interface shown in 10010 in the portrait screen state, and the terminal displays the exemplary view interface 10010 in the landscape screen state. Furthermore, in response to the display switching instruction triggered by the screen rotation operation, the terminal may determine the interface element to be displayed in the target view interface, namely, the image including the words “sample text” and several exemplary lines in the interface 10010, and determine the interface arrangement setting of the target view interface under the target interface orientation indicated by the display switching instruction. For example, in the example of FIG. 6, the interface arrangement setting may specifically be a related setting for presenting the interface element in the landscape screen orientation. Furthermore, the terminal may display the interface element to be displayed of the target view interface according to the interface arrangement setting, thereby determining the target view interface 10012 indicated by the display switching instruction.
102. Acquiring an auxiliary view interface displayed on an interface, where the auxiliary view interface includes a hollow area

The auxiliary view interface displayed on the interface refers to the view interface configured to assist in realizing the interface display during a device switching process from displaying the initial view interface to displaying the target view interface. For example, the auxiliary view interface displayed on the interface can be configured to present a dynamic transition from the initial view interface to the target view interface in a display area of the terminal (e.g., the display area determined by the display screen), so that the user can perceive the dynamic effect of the switching display of the view interface.

Taking the device switching process in which the terminal displays the initial view interface 10011 in FIG. 6 and switches to display the target view interface 10012 as an example, FIG. 7 shows a dynamic transition effect in the device switching process. In this example, the auxiliary view interface is a view interface configured to assist in realizing the dynamic transition effect.

The hollow area of the auxiliary view interface refers to the hollow area in the auxiliary view interface. Therefore, the hollow area is not a visible area in the auxiliary view interface. For example, it can be specifically manifested as that pixels can be assigned to the non-hollow area in the auxiliary view interface to change the color expression of the non-hollow area, while pixels cannot be assigned to the hollow area in the auxiliary view interface. For another example, if a lower layer of the auxiliary view interface has other visible view interface, the visible view interface can be observed through the hollow area, while the non-hollow area in the auxiliary view interface will obscure the visible view interface.

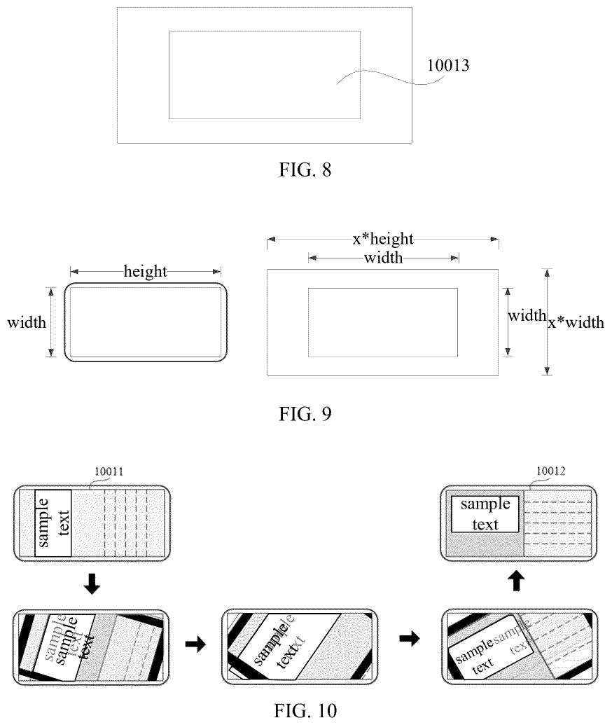

For example, refer to FIG. 8, which shows an example of an auxiliary view interface, where an area 10013 in the auxiliary view interface is the hollow area. It is worth noting that the shape and size of the auxiliary view interface, as well as the shape and size of the hollow area, can have many situations and can be set according to requirements.

There may be multiple methods for acquiring the auxiliary view interface displayed on the interface. For example, the terminal may acquire an interface setting information set, where the interface setting information set may include at least one interface setting information, and the terminal may determine the corresponding auxiliary view interface according to the interface setting information. Furthermore, the terminal can determine currently required interface setting information from the interface setting information set. For example, the terminal can determine matching interface setting information from the interface setting information set based on its own device information (such as size information of the display screen, etc.). For another example, the terminal can determine the matching interface setting information from the interface setting information set based on interface information of the initial view interface (such as size information of the initial view interface, etc.), and so on. Furthermore, the terminal can determine the auxiliary view interface displayed on the interface based on the determined interface setting information. For example, the terminal can draw the corresponding auxiliary view interface based on the determined interface setting information.

For another example, the terminal may store the interface setting information required to determine the auxiliary view interface. In this way, when the auxiliary view interface needs to be drawn, the interface can be drawn according to the interface setting information, thereby acquiring the auxiliary view interface displayed on the interface.

In one embodiment, the interface setting information of the auxiliary view interface may specifically include area setting information of the hollow area, so that the terminal can determine the hollow area in the view interface to be hollowed out according to the area setting information of the hollow area, and then determine the auxiliary view interface including the hollow area. Specifically, the step of “acquiring the auxiliary view interface displayed on the interface, the auxiliary view interface including the hollow area” may include:
determining area size information and area arrangement information of the hollow area, where the area arrangement information is configured to describe an area arrangement of the hollow area in the auxiliary view interface.
dividing the hollow area in a view interface of a target size according to the area size information and the area arrangement information.
drawing the divided view interface to acquire the auxiliary view interface displayed on the interface.

The area size information of the hollow area is related information configured to determine the area size of the hollow area. For example, the area size information of the hollow area may specifically indicate that the size of the hollow area is the same as the size of the display area of the terminal. For another example, the area size information of the hollow area may specifically indicate that the size of the hollow area is the same as the size of the initial view interface, and so on.

The area arrangement information of the hollow area is related information configured to determine the area arrangement of the hollow area. For example, the area arrangement information of the hollow area may specifically indicate that the hollow area is arranged at a specific position of the auxiliary view interface, such as a center position.

As an example, the area size information and the area arrangement information of the hollow area can be extracted from the interface setting information of the auxiliary view interface.

The view interface of the target size is a view interface required for generating the auxiliary view interface. Specifically, the view interface of the target size including the hollow area can be obtained by dividing the hollow area in the view interface of the target size.

As an example, the application scenario of the device switching shown in FIG. 6 can be taken as an example. The area size information of the hollow area can specifically indicate that the size of the hollow area is the same as the size of the display area of the terminal. The area arrangement information of the hollow area can specifically indicate that the hollow area is arranged at the center of the auxiliary view interface. Also, the target size of the view interface to be divided into the hollow area can specifically be x times (x is a positive number) of the display area of the terminal. Referring to FIG. 9, the hollow area can be divided in the view interface of the target size according to the determined area size information and area arrangement information. A height is configured to refer to a height of the display area of the terminal, and a width is configured to refer to a width of the display area of the terminal.

In one embodiment, after dividing the hollow area in the view interface of the target size, the view interface may also include a mask area composed of the non-hollow area. In this way, in the process of the device switching, in addition to providing a visible range presented to the user through the hollow area in the auxiliary view interface and presenting the transformation process of the visible view interface within the visible range, the mask area in the auxiliary view interface can be configured to mask a portion of a lower-layer view interface. When a transformation processing is performed on the view interface, the mask area can be configured to improve the dynamic effect of the device switching, so that during the device switching process, a transformation dynamic effect of view interface that can be visually perceived by the user can be presented. Specifically, the step of “drawing the divided view interface” may include:
determining a mask area in the view interface of the target size according to a division result.
determining drawing parameter information of the mask area.
drawing the divided view interface according to the drawing parameter information.

In the present application, the mask area can be determined in the non-hollow area in the view interface of the target size. For example, the non-hollow area can be directly determined as the mask area.

The drawing parameter information of the mask area refers to relevant information of parameters required when drawing the mask area. For example, the required parameters may include resolution adjustment parameters, pixel value setting parameters, contrast adjustment parameters, etc.

In one embodiment, setting the mask area in the auxiliary view interface to a mask area with a background color may be taken as an example. As an example, in actual applications, the mask area of the auxiliary view interface may be set to black. In this way, through the mask area and the hollow area, during the device switching process, the view interface in the transformation of the lower layer of the auxiliary view interface can present a visual effect with a border. Moreover, by providing a black background visual effect through the black mask area, the transformation (such as scaling, rotation) process of the initial view interface and the target view interface can be vividly presented during the device switching process. In this way, through the hollow area and the black mask area in the auxiliary view interface, the device switching process from the initial view interface to the target view interface can be visually perceptible to the user, thereby improving the dynamic effect of the device switching.

It is worth noting that pixel values of the mask area in the auxiliary view interface can be set as needed. For example, if edge areas of the initial view interface and the target view interface are both light-colored, the mask area can be set to black. If the edge areas of the initial view interface and the target view interface are both black, the mask area can be set to white. For another example, an initial color of the mask area can be determined according to a color distribution of the initial view interface, and a target color of the mask area can be determined according to a color distribution of the target view interface. Also, in the device switching process from displaying the initial view interface to displaying the target view interface, the mask area of the auxiliary view interface is controlled to switch from the initial color to the target color as the transformation progresses. For another example, the mask area in the auxiliary view interface can be set to a non-pure color, and an area with gradient, texture, and other effects. For another example, the pixel values in the mask area can be set according to pixel values in a preset image, so that the mask area can present the visual effect of the preset image.

In the present application, after determining the mask area in the view interface of the target size and determining the drawing parameter information of the mask area, the terminal can draw the divided view interface according to the drawing parameter information, and use the drawn and divided view interface as the auxiliary view interface displayed on the interface. In this case, the auxiliary view interface displayed on the interface includes the hollow area and the mask area corresponding to the drawing parameter information.

In the present application, it is considered that during the device switching process, the auxiliary view interface, the initial view interface, and the target view interface can all be subjected to the transformation processing. For example, the auxiliary view interface can be subjected to a rotation processing and a scaling processing. In order to ensure that the auxiliary view interface can cover the display area of the terminal even during the transformation process, and to avoid the problem that after the auxiliary view interface is transformed to a certain position, the mask area cannot cover the lower-layer view interface, thus affecting the device switching effect, as shown in FIG. 10, the mask area in the auxiliary view interface can be set to always cover the display area of the terminal during the device switching process.

In one embodiment, the auxiliary view interface may include the hollow area, and the non-hollow area in the auxiliary view interface may be used as the mask area of the auxiliary view interface. Therefore, in order to avoid the phenomenon shown in FIG. 10 during the device switching process, the target size of the view interface to be divided into the hollow area may be set according to a distance between the hollow area and the terminal display area during the device switching process. This ensures that the view interface under the target size, after being divided into the hollow area, can always have its mask area cover a lower-layer view interface during the device switching process. It prevents the lower-layer view interface, which should have been masked as an invisible area for the user, from appearing as a visible area to the user due to insufficient size of the mask area during the device switching process. Specifically, the step of “dividing the hollow area in the view interface of the target size according to the area size information and the area arrangement information” may include:
determining a target distance feature of the hollow area according to a target interface orientation indicated by the display switching instruction, where the target distance feature represents a distance between the hollow area and a terminal display area.
analyzing the target distance feature to determine a target size of the view interface of the hollow area to be divided.
dividing the hollow area in the view interface corresponding to the target size according to the area size information and the area arrangement information.

The target distance feature of the hollow area refers to a feature that can represent the distance between the hollow area and the terminal display area during the device switching process. For example, since the non-hollow area in the auxiliary view interface can be used as the mask area of the auxiliary view interface, the distance between an edge of the hollow area and an edge of the terminal display area during the device switching process can be used as the target distance feature of the hollow area.

It is worth noting that in the present application, the target distance feature of the hollow area is calculated in order to use the target distance feature as reference data for setting the size of the mask area of the auxiliary view interface, so that the mask area of the auxiliary view interface can always cover its lower-layer view interface during the device switching process. Therefore, when calculating the distance between the edge of the hollow area and the edge of the terminal display area during the device switching, the distance between the edge of the hollow area and the edge of the terminal display area can be calculated only when the portion between the edge of the hollow area and the edge of the terminal display area can constitute the mask area, and the calculated distance is used as the target distance feature of the hollow area.

Considering that the target distance feature of the hollow area can be used as a reference for setting the size of the mask area of the auxiliary view interface, in order to ensure that the mask area of the auxiliary view interface can always cover its lower-layer view interface during the device switching process, the target distance feature of the hollow area can be analyzed. For example, for a variable of the target distance feature, its maximum value max during the device switching process is taken, and the target size of the view interface to be divided into the hollow area is set based on max.

For example, the setting of the hollow area and the mask area in the auxiliary view interface can be taken as shown in FIG. 9. In order to ensure that the mask area of the auxiliary view interface can always cover its lower-layer view interface during the device switching process, x≥max can be set to determine the target size of the view interface to be divided into the hollow area. For example, the value of x can be set to max, and then the target size of the view interface to be divided into the hollow area can be determined as: the width is max*width, and the height is max*height.

After determining the target size of the view interface of the hollow area to be divided, the hollow area can be further divided in the view interface corresponding to the target size according to the area size information and area arrangement information of the hollow area, and the divided view interface is used as the auxiliary view interface to be drawn. In this way, the drawn auxiliary view interface includes the hollow area and the mask area that can ensure that the lower-layer view interface can always be covered during the device switching process.

It is worth noting that in the present application, the step 102 is before the step 103 and the step 104. That is, before an animation of the device switching starts, the auxiliary view interface displayed on the interface is acquired and drawn in advance. In this way, it is possible to avoid the need to redraw the auxiliary view interface for each frame during the animation process of the device switching, thereby greatly reducing the system's drawing pressure and avoiding problems such as drawing timeouts and animation stuttering that affect the dynamic effects of the device switching. This helps ensure good animation drawing performance during the device switching.
103. Performing a superposition processing on the initial view interface, the target view interface, and the auxiliary view interface to obtain a view interface sequence in which the auxiliary view interface is placed on an upper layer.

The superposition processing refers to a s process of superimposing various view interfaces. For example, by performing the superposition processing on the initial view interface, the target view interface, and the auxiliary view interface, the view interface sequence including the initial view interface, the target view interface, and the auxiliary view interface can be obtained.

It is worth noting that in the view interface obtained after the superposition processing in this application, the auxiliary view interface is placed in the upper layer. That is, the auxiliary view interface is the view interface in the uppermost layer of the view interface sequence. In this application, a main orientation can be the interface perpendicular to the terminal display area and directed towards to the user. In this case, the auxiliary view interface is the view interface in the uppermost layer of the view interface sequence, which means that the auxiliary view interface is the view interface closest to the user in the view interface sequence.

In actual applications, in order to improve the device switching effect, the target view interface can be rotated according to the target interface orientation indicated by the display switching instruction, and then the initial view interface, the rotated target view interface, and the auxiliary view interface are subjected to the superposition processing to obtain the view interface sequence that places the auxiliary view interface in the upper layer. This allows the subsequent transformation processing (such as rotation processing) of the view interface sequence to present the display from the initial view interface to the target view interface based on the hollow area, providing a better device switching effect. For example, it can create a visual effect where the target view interface “gradually enters the terminal display area.”

As an example, a device switching scenario shown in FIG. 6 can be taken as an example. According to the target interface orientation indicated by the display switching instruction, the target view interface can be rotated 90 degrees counterclockwise to obtain the rotated target view interface as shown in FIG. 11. In addition, the auxiliary view interface can be set according to a view setting mechanism shown in FIG. 9, where the specific value of x can be 1.6, and the mask area in the auxiliary view interface can be set to black, thereby obtaining the initial view interface, the target view interface, and the auxiliary view interface to be subjected to the superposition processing as shown in FIG. 11.

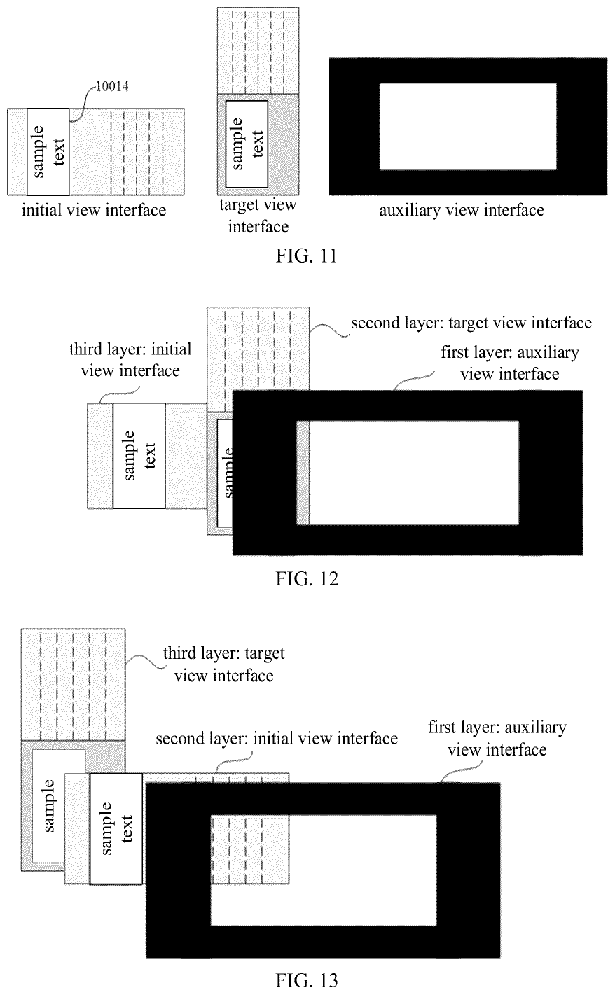

In one embodiment, there are multiple methods for performing the superposition processing on the initial view interface, the target view interface, and the auxiliary view interface according to a superposition order between the view interfaces, and obtaining the view interface sequence for placing the auxiliary view interface in the upper layer. Taking a device switching scenario shown in FIG. 11 as an example, the initial view interface, the target view interface, and the auxiliary view interface can be superposed from bottom to top. Specifically, as shown in FIG. 12, the initial view interface can be used as a third layer, i.e., a bottom layer, and the target view interface can be superposed on the initial view interface as a second layer, i.e., a middle layer. Furthermore, the auxiliary view interface can be superposed on the target view interface as a first layer, i.e., the upper layer, thereby obtaining the view interface sequence in which the auxiliary view interface is placed in the upper layer. As another example, the target view interface, the initial view interface, and the auxiliary view interface can be superposed from bottom to top. Specifically, as shown in FIG. 13, the target view interface can be used as the third layer, i.e., the bottom layer, and the initial view interface can be used as the second layer, i.e., the middle layer. Furthermore, the auxiliary view interface can be superposed on the initial view interface as the first layer, i.e., the upper layer, thereby obtaining the view interface sequence in which the auxiliary view interface is placed in the upper layer.

In one embodiment, considering that the hollow area in the auxiliary view interface located in the upper layer can be configured to display the content in the view interface below the auxiliary view interface, when the superposition processing is performed on the view interface, a target focus area in each view interface can be determined, and the initial view interface, the target view interface, and the auxiliary view interface can be subjected to the superposition processing according to the determined target focus area, so that when the device switching starts, the target focus area in the view interface below the auxiliary view interface can be presented through the hollow area in the auxiliary view interface located in the upper layer, thereby improving the device switching effect. Specifically, the step of “performing the superposition processing on the initial view interface, the target view interface, and the auxiliary view interface” may include:
respectively determining target focus areas of the initial view interface, the target view interface, and the auxiliary view interface.
performing the superposition processing on the initial view interface, the target view interface, and the auxiliary view interface according to the determined target focus areas.

The target focus area of a view interface refers to an area in the view interface that has a higher level of attention. Taking the initial view interface shown in FIG. 11 as an example, for example, an area 10014 where the “sample text” is located in the view interface can be used as the target focus area of the view interface, and for another example, a central area of a preset size in the view interface can be used as the target focus area, and so on.

Since the target focus area of the view interface is configured to refer to the area with a higher level of attention in the view interface, when performing the superposition processing on each view interface, the target focus area in the view interface can be placed below the hollow area in the auxiliary view interface, so that the area with the higher level of attention in the view interface can be presented to the user during the device switching process. In this way, a higher user experience can also be provided to the user during the device switching process.

There are many ways to determine the target focus area in the view interface. In one embodiment, the preset size area of the view interface at a preset position can be used as the target focus area. For example, the preset size area of the view interface at the center of the interface is used as the target focus area. It is worth noting that the selection of the preset position and the preset size can be set according to business needs. For example, it can be set based on user habits. For another example, it can be set based on the interface property of the view interface, and so on.

In another embodiment, considering that the view interface may include at least one interface element, such as an interface element for displaying a video image, an interface element for displaying a picture, an interface element for a user to display text, etc., a focused target interface element can be determined from the interface elements of the view interface, and then the area where the target interface element is located is determined as the target focus area of the view interface.

As an example, the view interface may be a target view interface, and the target view interface may include at least one interface element. Specifically, the step of “determining the target focus area of the target view interface” may include:
determining a focused target interface element from interface elements of the target view interface.
determining the target focus area of the target view interface according to element arrangement information of the target interface element in the target view interface.

The interface element of the view interface refers to the elements included in the view interface. For example, there can be many ways to distinguish the interface elements. For example, the interface element can be determined according to the view content included in the view interface. For example, the interface element can include an interface element for displaying a video image, an interface element for displaying a picture, an interface element for a user to display text, and so on. For another example, the interface element can be determined based on structural information of the view interface. For example, if the view interface is specifically an interface corresponding to a Hypertext Markup Language (HTML) web page, the interface element can include HTML elements, and so on.

In the present application, the target interface element refers to an interface element that is given a higher level of attention. There are many ways to determine the focused target interface element from the target view interface. For example, the target interface element can be determined according to the type of the target view interface. For example, if the target view interface is a view interface of a video playback type, the interface element configured to display the video image can be determined as the target interface element. For example, if the target view interface is a view interface of a conversation chat type, the interface element configured to display the conversation chat area can be determined as the target interface element, and so on. For another example, different types of interface elements can be given different priorities. In this way, the interface element with the highest priority can be determined as the target interface element from the interface elements of the target view interface.

The element arrangement information of interface elements in a view interface can be configured to describe an arrangement of the interface elements in the view interface. The element arrangement information of the interface elements in the view interface can specifically include size information of the interface elements and position information of the interface elements in the view interface.

After determining the target interface element of the target view interface, the target focus area of the target view interface can be further determined according to the element arrangement information of the target interface element in the target view interface. For example, an area in the target view interface that has the same size information and position information as the target interface element can be used as the target focus area. For another example, a preset size area that includes the target interface element in the target view interface can be used as the target focus area, and so on. The specific settings can be made according to needs and effects, and this application does not limit this.

Similarly, the initial view interface may include at least one interface element, and the step of “determining the target focus area of the target view interface” may include: determining the focused target interface element from the interface elements of the initial view interface; and determining the target focus area of the initial view interface according to the element arrangement information of the target interface element in the initial view interface. For details, please refer to the relevant description in the step of “determining the target focus area of the target view interface”, which will not be repeated here.

In the present application, after the target focus areas of the initial view interface and the target view interface are determined respectively, the initial view interface, the target view interface, and the auxiliary view interface can be further subjected to the superposition processing according to the determined target focus areas. For example, on the basis of determining a superposition order between the view interfaces, an alignment method between the view interfaces can be determined according to the determined target focus area, and then the initial view interface, the target view interface, and the auxiliary view interface can be subjected to the superposition processing according to the superposition order and the alignment method. There are many ways to determine the alignment method between the view interfaces according to the determined target focus area. For example, the target focus area of the initial view interface, the target focus area of the target view interface, and the hollow area of the auxiliary view interface can be centered to determine the alignment method between the initial view interface, the target view interface, and the auxiliary view interface.

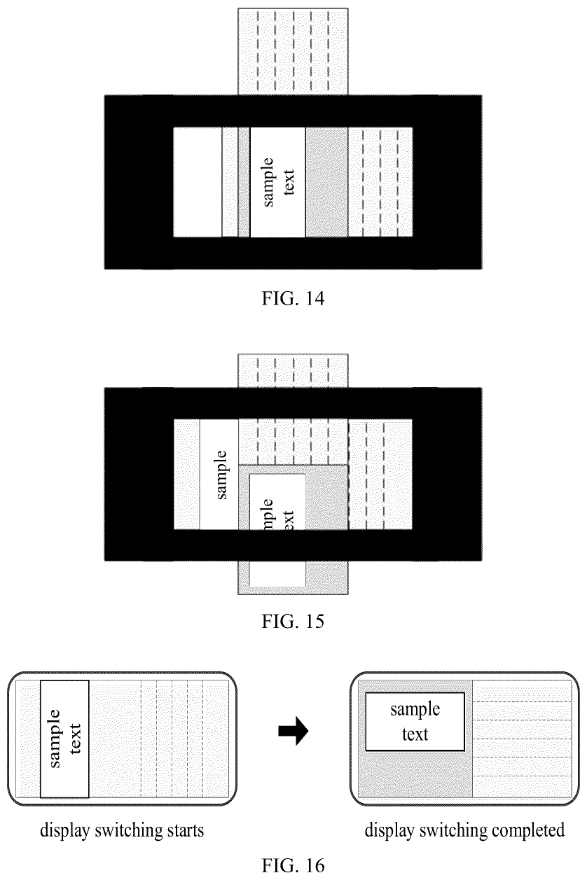

Taking the view interface shown in FIG. 11 as an example, for example, the target focus area of the area where the “sample text” in the initial view interface and the target view interface is located, and the target focus area of the initial view interface, the target focus area of the target view interface, and the hollow area of the auxiliary view interface can be centered. Also, the superposition processing is performed on each view interface in a superposition order shown in FIG. 12, and a specific superposition result can be referred to FIG. 14. For another example, the central area in the initial view interface and the target view interface can be used as the target focus area, and the target focus area of the initial view interface, the target focus area of the target view interface, and the hollow area of the auxiliary view interface can be aligned in the center. Also, the superposition processing is performed on each view interface in the superposition order shown in FIG. 12, and a specific superposition result can be referred to FIG. 15.
104. Performing a transformation processing on the view interface sequence to present a display from the initial view interface to the target view interface based on the hollow area.

In the present application, the view interface sequence may include an auxiliary view interface located in an upper layer, and an initial view interface and a target view interface located below the auxiliary view interface. Therefore, the transformation processing of the view interface sequence may be achieved by performing the transformation processing on the auxiliary view interface, the target view interface, and the initial view interface in the view interface sequence.

The transformation processing of the view interface refers to the transformation of the view interface to enable better dynamic effects during the device switching. For example, the transformation processing may include a scaling transformation processing for an interface size of the view interface, a rotation transformation processing and a translation transformation processing for an interface position of the view interface, and a property transformation processing for interface properties of the view interface (such as transparency, contrast, etc.).

In the present application, during the device switching process, the hollow area in the auxiliary view interface placed in the upper layer of the view interface sequence can be configured to provide a visible range presented to the user. Therefore, the dynamic switching process from displaying the initial view interface to displaying the target view interface can be presented based on the hollow area.

In one embodiment, during the device switching process of switching from displaying the initial view interface to displaying the target view interface, an interface property of the view interface in the view interface sequence may be adjusted. For example, the interface property of the target view interface and the initial view interface in the view interface sequence may be adjusted to present the property change process of the initial view interface and the target view interface based on the hollow area in the auxiliary view interface during the device switching. Specifically, the step of “performing the transformation processing on the view interface sequence” may include:
in a display process from the initial view interface to the target view interface, acquiring current display progress information, and adjusting an interface property of a view interface in the view interface sequence according to the display progress information, so as to perform the transformation processing on the view interface sequence.

The interface property of the view interface refers to a property that affect the visual effects of the view interface. For example, the interface property of the view interface may include the transparency, contrast, brightness, etc. of the view interface.

The display progress information refers to relevant information indicating the current progress of device switching during the process from the start of device switching to the completion of device switching, that is, the relevant information indicating the current progress of switching from displaying the initial view interface to displaying the target view interface.

As an example, in order to present a visual effect that the initial view interface gradually “fades out” while the target view interface gradually “enhances” during the process of switching from displaying the initial view interface to displaying the target view interface, the interface properties of the view interfaces in the view interface sequence are adjusted according to the display progress information. Specifically, it may include: adjusting the interface properties of the initial view interface and the target view interface in the view interface sequence according to the display progress information.

For example, if the interface property is transparency, the transparency of the initial view interface can be controlled to be set to 1 at the beginning of the device switching. Also, during the device switching process, according to the display progress information, the transparency of the initial view interface is controlled to gradually decrease until it is set to 0 at the end of the device switching. Correspondingly, the transparency of the target view interface can be controlled to be set to 0 at the beginning of the device switching. Also, during the device switching process, according to the display progress information, the transparency of the target view interface is controlled to gradually increase until it is set to 1 at the end of the device switching.

As another example, when an edge area of the view interface is light-colored, the mask area suitable for highlighting the view interface may be black. Also, when the edge area of the view interface is dark-colored, the mask area suitable for highlighting the view interface may be white. Therefore, in the process from displaying the initial view interface to displaying the target view interface, if a color distribution of the edge area of the initial view interface is significantly different from that of an edge area of the target view interface, in order to maximize the highlighting of the initial view interface and the target view interface by the mask area of the auxiliary view interface during the device switching, the interface property of the view interface in the view interface sequence is adjusted according to the display progress information. Specifically, it may also include: adjusting the interface property of the auxiliary view interface in the view interface sequence according to the display progress information.

For example, an initial color of the mask area of the auxiliary view interface can be determined based on the color distribution of the edge area of the initial view interface, and a target color of the mask area of the auxiliary view interface can be determined based on the color distribution of the edge area of the target view interface. Furthermore, the color of the auxiliary view interface can be controlled to be set to the initial color at the beginning of the device switching, and during the device switching process, the color of the auxiliary view interface can be controlled to gradually transition to the target color based on the display progress information until it is set to the target color at the end of the device switching.

It is worth noting that the above only takes the interface property of the view interface, which is specifically transparency and background color, as an example. In actual applications, the interface property may also include other situations. In addition, it may also include the situation where multiple interface properties of the view interface in the view interface sequence are adjusted according to the display progress information. This application does not limit the number and type of interface properties to be adjusted, and they can be adjusted as needed.

In one embodiment, the device switching process from displaying the initial view interface to displaying the target view interface may be specifically a process of displaying across interface orientations. Therefore, in order to improve the dynamic effect during the device switching process, each view interface in the view interface sequence may be subjected to a rotation transformation processing according to the target interface orientation indicated by the display switching instruction, so as to present rotation transformation of each view interface across interface orientations during the device switching process based on the hollow area of the auxiliary view interface. Specifically, the step of “performing the transformation processing on the view interface sequence to present the display from the initial view interface to the target view interface based on the hollow area” may include:
determining a rotation orientation of each view interface in the view interface sequence according to a target interface orientation indicated by the display switching instruction.
performing a rotation transformation processing on each view interface in the view interface sequence according to the rotation orientation to present a rotation transformation of a view interface under the auxiliary view interface in a display process from the initial view interface to the target view interface based on the hollow area of the auxiliary view interface.

The target interface orientation indicated by the screen switching instruction refers to an interface orientation corresponding to the target view interface when switching from the initial view interface to the target view interface. The rotation orientation of the view interface indicates an orientation to which the view interface should rotate from a rotation state corresponding to the start of the device switching to a rotation state corresponding to the completion of the device switching.

The rotation transformation processing refers to a transformation processing achieved by rotating the view interface.

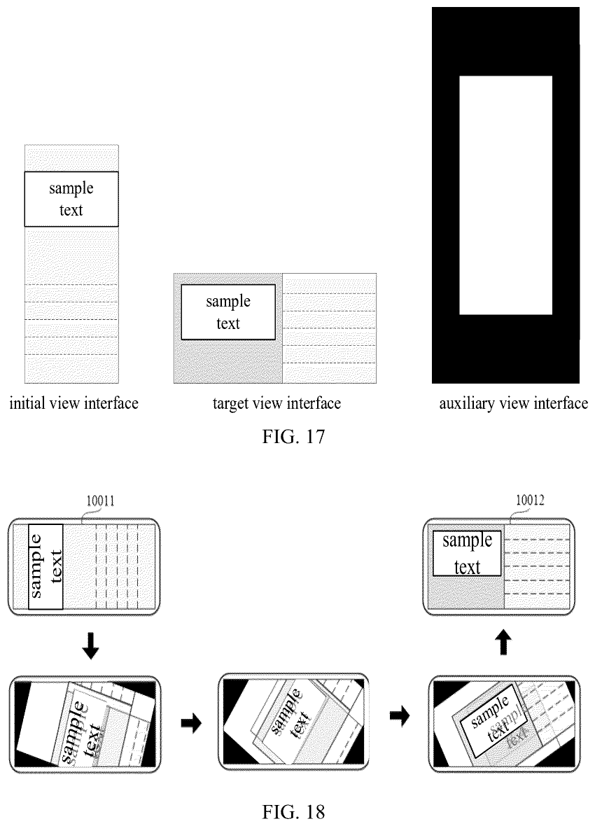

As an example, the application scenario of the device switching shown in FIG. 6 can be taken as an example, and FIG. 16 shows an initial stage and a completion stage of the device switching in the device switching process of the application scenario. Also, FIG. 11 shows corresponding rotation states of the initial view interface, the target view interface, and the auxiliary view interface in the initial stage of the device switching in this example. It can be seen that the rotation orientation of the target view interface in the view interface sequence can be determined to be rotated 90 degrees to the right according to the target interface orientation indicated by the display switching instruction. Further, it can be determined that the rotation orientation of the initial view interface and the auxiliary view interface in the view interface sequence are also rotated 90 degrees to the right. It can be seen that in this example, the rotation orientation of each view interface in the view interface sequence can be determined to be rotated 90 degrees to the right according to the target interface orientation indicated by the display switching instruction. Also, the rotation state corresponding to each rotated view interface can be specifically referred to as shown in FIG. 17.

After determining the rotation orientation of each view interface in the view interface sequence, the rotation transformation processing can be performed on each view interface in the view interface sequence according to the determined rotation orientation, so as to present the rotation transformation of the view interface under the auxiliary view interface in the display process from the initial view interface to the target view interface based on the hollow area of the auxiliary view interface. For example, in the above example, during the device switching process, the process of each view interface transforming from the rotation state shown in FIG. 11 to the rotation state shown in FIG. 17 can be presented based on the hollow area of the auxiliary view interface.

In one embodiment, considering the device switching process of switching from displaying the initial view interface to displaying the target view interface, in addition to presenting the display dynamic effect from the perspective of rotation transformation by adjusting the rotation state of each view interface, an interface size of each view interface can also be adjusted to provide a better device switching dynamic effect. Specifically, the step of “performing the transformation processing on the view interface sequence to present the display from the initial view interface to the target view interface based on the hollow area” may include:
determining size adjustment information of a view interface in the view interface sequence.
performing a size adjustment transformation processing on the view interface in the view interface sequence according to the size adjustment information to present a size adjustment of a view interface under the auxiliary view interface during a display process from the initial view interface to the target view interface based on the hollow area of the auxiliary view interface.

The size adjustment transformation processing refers to a transformation processing achieved by performing a size adjustment on the view interface.

In the present application, there are many ways to implement the size adjustment. For example, a size of the view interface can be adjusted by scaling the view interface; or the size of the view interface can be adjusted by adjusting a shape of the view interface, and so on.

The size adjustment information of the view interface is configured to indicate a size adjustment operation to be performed on the view interface.

Specifically, the size adjustment information corresponding to each view interface in the view interface sequence can be determined, and according to the size adjustment information corresponding to the view interface, the size adjustment transformation processing can be performed on the view interface during the device switching.

In the present application, the auxiliary view interface including the hollow area is placed in the upper layer of the view interface sequence because in this way, the transformation of the lower view interface can be dynamically displayed by utilizing hollow characteristics of the hollow area during the device switching process. In one embodiment, considering that the view interface under the auxiliary view interface is scaled during the device switching process, a scaling threshold can be set for the view interface under the auxiliary view interface to avoid the problem that, during the device switching process, the scaled interface size of the lower view interface of the auxiliary view interface is smaller than an area size of the hollow area, resulting in the system default background (as an example, the system default background in FIG. 18 is white) being presented in the visible range presented based on the hollow area, thereby resulting in a poor device switching effect, as shown in FIG. 18. Specifically, the size adjustment information may indicate that the size adjustment is achieved by performing a scaling transformation on the view interface under the auxiliary view interface. The step of “performing the size adjustment transformation processing on the view interface in the view interface sequence according to the size adjustment information” may include:
acquiring area size information of the hollow area of the auxiliary view interface.
determining a scaling threshold for the view interface under the auxiliary view interface according to the area size information.
performing the size adjustment transformation processing on the view interface under the auxiliary view interface in the view interface sequence based on the size adjustment information and the scaling threshold.

The area size information of the hollow area refers to relevant information indicating the area size corresponding to the hollow area during the device switching process. It is worth noting that during the device switching process, the auxiliary view interface including the hollow area can be dynamically adjusted in size, so that the area size of the hollow area during the device switching process is not fixed, but can change dynamically with the progress of the device switching. Therefore, the area size information acquired here can indicate the area size of the hollow area under different device switching progress during the device switching process.

The scaling threshold of the view interface under the auxiliary view interface refers to a threshold set for the scaled interface size of the view interface under the auxiliary view interface during the device switching. Specifically, during the device switching, if the view interface under the auxiliary view interface is scaled, the scaled size of the view interface can be set to be≥the scaling threshold.

In the present application, in order to avoid the problem that during the device switching process, the scaled interface size of the view interface under the auxiliary view interface is smaller than the area size of the hollow area, which results in the system default background (as an example, the system default background in FIG. 18 is white) being presented in the visible range based on the hollow area, thereby causing the device switching effect to be poor, the scaling threshold of the view interface under the auxiliary view interface during the device switching process can be specifically set to the area size of the hollow area. In this way, during the device switching process, if the view interface under the auxiliary view interface is scaled, it can be ensured that the scaled size of the view interface is≥the scaling threshold, thereby avoiding similar problems as shown in FIG. 18. For example, it can be set that during the device switching process, if the view interface under the auxiliary view interface is scaled proportionally, a width of the scaled size of the view interface is always≥a width of the area size of the hollow area.

After acquiring the area size information of the hollow area and the scaling threshold of the view interface under the auxiliary view interface, a scaling transformation processing can be performed on the view interface under the auxiliary view interface in the view interface sequence during the device switching based on the size adjustment information and the scaling threshold.

In one embodiment, considering that the view interface under the auxiliary view interface in the view interface sequence may include at least one interface element, when performing the scaling transformation processing on the view interface, a focused target interface element of the scaling transformation processing may be determined from the interface element of the view interface, and then the area where the target interface element is located is determined as the scaling center area of the view interface. In this way, the scaling transformation processing may be performed on the view interface according to the scaling center area, so that during the device switching, even if the size of the view interface changes dynamically due to the scaling transformation processing, the target interface element may still be displayed to the user within the visible range determined based on the hollow area. Specifically, the step of “performing the size adjustment transformation processing on the view interface under the auxiliary view interface in the view interface sequence” may include:
determining a focused target interface element of a scaling transformation processing from interface elements of the view interface.
determining a scaling center area of performing the scaling transformation on the view interface according to element arrangement information of the target interface element in the view interface.
performing the scaling transformation processing on the view interface based on the scaling center area.

Specifically, for the definition of the interface element of the view interface, please refer to the above and will not be repeated here.

The size adjustment information of the view interface is configured to indicate the size adjustment operation to be performed on the view interface. For example, the size adjustment information of the view interface under the auxiliary view interface can be configured to indicate the size adjustment to be performed on the view interface to achieve the size adjustment.

The focused target interface element of the scaling transformation processing refers to the interface element that is given a higher level of attention during the scaling transformation processing of the view interface. Specifically, the method for determining the focused target interface element of the scaling transformation processing from the interface elements of the view interface can be referred to the implementation method of the aforementioned step “determining the focused target interface element from the interface elements of the target view interface”, which is not repeated here.

After determining the scaling center area for the scaling transformation of the view interface, the scaling transformation processing can be further performed on the view interface based on the scaling center area. As an example, during the device switching, if the scaling transformation processing is performed on the view interface under the auxiliary view interface, the scaling center area of the view interface can be placed at the center of the visible range determined by the hollow area, and the scaling center area is used as the scaling center to perform the scaling transformation processing on the view interface.

In one embodiment, when performing the transformation processing on the auxiliary view interface across interface orientations, for example, taking the rotation transformation processing on the auxiliary view interface across interface orientations as an example, there is a situation where the hollow area in the auxiliary view interface after rotation does not match the shape of the terminal display area. As an example, the device switching application scenario shown in FIG. 6 can be taken as an example, and FIG. 17 shows a state corresponding to the auxiliary view interface after the rotation transformation processing is performed on the auxiliary view interface during the device switching process of the example. It can be seen that the hollow area in the auxiliary view interface after the rotation in FIG. 17 does not match the display area of the terminal when the device switching is completed in the example in FIG. 16. Therefore, the problem can be solved by performing a shape transformation on the auxiliary view interface during the device switching process. Specifically, the view interface sequence may include the auxiliary view interface, and the size adjustment information may specifically indicate that size adjustment is achieved by performing the shape transformation on the auxiliary view interface. The step of “performing the size adjustment transformation processing on the view interface in the view interface sequence according to the size adjustment information” may include:
analyzing the size adjustment information to obtain an initial shape and a target shape of the auxiliary view interface.
in the display process from the initial view interface to the target view interface, acquiring current display progress information, and according to the display progress information, transforming the auxiliary view interface from the initial shape to the target shape, so as to perform a shape transformation processing on the auxiliary view interface.

The size adjustment information of the view interface is configured to indicate a size adjustment operation to be performed on the view interface. For example, the size adjustment information of the auxiliary view interface can be configured to indicate the shape transformation to be performed on the auxiliary view interface to achieve the size adjustment.

For example, the size adjustment information of the auxiliary view interface may include the initial shape and the target shape corresponding to the shape transformation of the auxiliary view interface. For example, the shape transformation of the auxiliary view interface may be achieved by transforming the auxiliary view interface from the initial shape to the target shape.

In the present application, the auxiliary view interface can be transformed from the initial shape to the target shape during the device switching process. Specifically, the auxiliary view interface can be set to be presented in the initial shape when the device switching starts, and as the device switching progresses, the auxiliary view interface can be gradually switched from the initial shape to the target shape until the auxiliary view interface is set to be presented in the target shape when the device switching is completed.

As an example, taking the device switching application scenario shown in FIG. 6 as an example, the auxiliary view interface in FIG. 11 shows an initial shape corresponding to the auxiliary view interface during the initial stage of the device switching. Since FIG. 17 shows the state of the auxiliary view interface after the rotation transformation processing is performed on the auxiliary view interface during the device switching process of this example, that is, FIG. 17 shows an expected shape of the auxiliary view interface at an end stage of the device switching if only the auxiliary view interface is subjected to the rotation transformation processing but not the shape transformation processing. If the expected shape is set as the target shape, since the expected shape of the auxiliary view interface in FIG. 17 does not match the display area of the terminal when the device switching is completed in the example in FIG. 16, it can be seen that the setting is not appropriate. Therefore, in order to make the target shape of the auxiliary view interface match the display area of the terminal when the device switching is completed in the example in FIG. 16, the target shape of the auxiliary view interface can be set to the shape corresponding to the auxiliary view interface in FIG. 11.

Specifically, in this example, the initial shape of the auxiliary view interface is consistent with the target shape based on the rotation transformation processing and the shape transformation processing of the auxiliary view interface during the device switching process. Therefore, this does not mean that the auxiliary view interface is not subjected to the shape transformation during the device switching process. In addition, during the process of switching the auxiliary view interface from the initial shape to the target shape, it can be achieved by setting the auxiliary view interface from an original length to a width of a new state, and from an original width to a length of the new state.

As can be seen from the above, this embodiment can determine the target view interface indicated by the display switching instruction in response to the display switching instruction for the currently displayed initial view interface; acquire the auxiliary view interface displayed on the interface, and the auxiliary view interface includes the hollow area; perform the superposition processing on the initial view interface, the target view interface, and the auxiliary view interface to obtain the view interface sequence in which the auxiliary view interface is placed on the upper layer; and perform the transformation processing on the view interface sequence to present the display from the initial view interface to the target view interface based on the hollow area.

In the device switching process from displaying the initial view interface to displaying the target view interface, the solution can present a dynamic transition from the initial view interface to the target view interface through the auxiliary view interface with the hollow area, so that the user can actually perceive the switch display of the view interface. In addition, since only the initial view interface, the target view interface, and the auxiliary view interface are involved in the device switching process, the solution can avoid the time consumption and computing resource consumption caused by the large number of layers involved, thereby improving the display dynamic effect of the interface and improving the display efficiency of the interface.

In addition, since the solution acquires the auxiliary view interface before presenting the animation effect of the device switching by performing the transformation processing on the view interface sequence, the solution can pre-draw the auxiliary view interface required for the device switching before the animation of the device switching begins. This can reduce the computing burden of the system during the animation process of the device switching, thereby ensuring good drawing performance during the animation process of the device switching and avoiding problems such as drawing timeouts and animation stuttering due to too many drawing tasks, thereby further improving the display dynamic effect of the interface and improving the display efficiency of the interface.

According to the method described in the above embodiment, the following will give an example to further explain in detail.

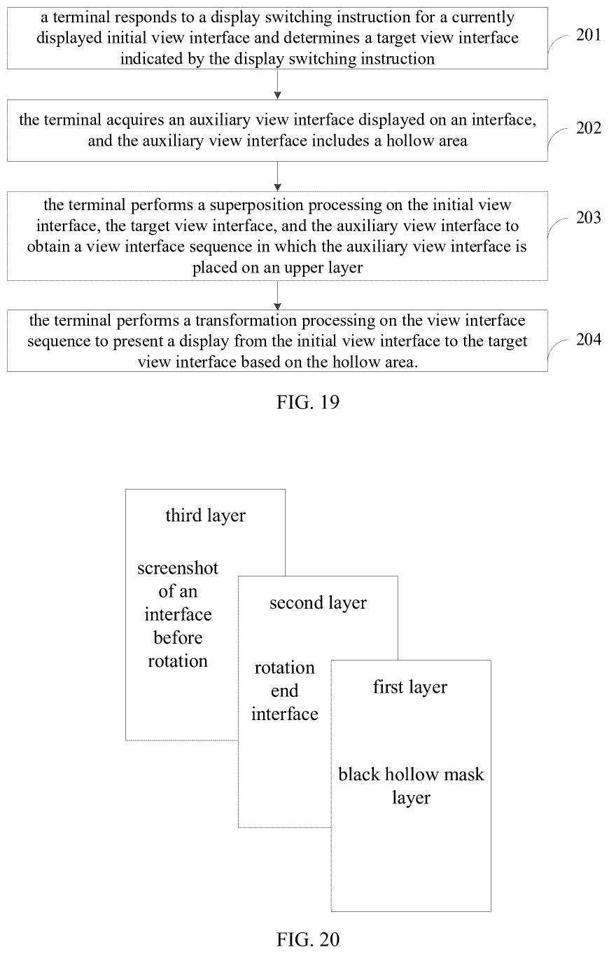

In this embodiment, an interface display apparatus integrated in a terminal will be used as an example for explanation, as shown in FIG. 19, an interface display method, the specific process is as follows:
201. In response to a display switching instruction for a currently displayed initial view interface, a terminal determines a target view interface indicated by the display switching instruction.

For example, the display switching instruction may be specifically an instruction triggered by a screen switching instruction, such as the screen switching instruction may include an instruction for rotating a display screen when the terminal is rotated. The initial view interface may be specifically an interface before the terminal is rotated, and the target view interface may be an interface after the terminal is rotated.

The terminal can acquire the initial view interface by acquiring a screenshot of the interface before rotation, and can acquire a rotation end interface by calling an interface provided by a system. For example, taking an Android system as an example, it can acquire by calling a DisplayContent.getSurfaceControl() method.
202. The terminal acquires the auxiliary view interface displayed on the interface, and the auxiliary view interface includes a hollow area.

For example, the auxiliary view interface may be specifically a layer as shown in a right figure of FIG. 9, including the hollow area having a size consistent with a size of the terminal and a non-hollow mask area. As an example, the mask area may be set to black, so the auxiliary view interface displayed on the interface may be specifically a black hollow mask layer.
203. The terminal performs a superposition processing on the initial view interface, the target view interface, and the auxiliary view interface to obtain a view interface sequence in which the auxiliary view interface is placed on an upper layer.

For example, referring to FIG. 20, the superposition processing can be performed on the screenshot of the terminal's interface before rotation, the interface after rotation, and the black hollow mask layer to obtain the view interface sequence after the superposition processing. The black hollow mask layer is placed in the upper layer of the view interface sequence, which is a first layer. The interface after rotation is placed in a middle layer of the view interface sequence, which is a second layer. The screenshot of the interface before rotation is placed in a bottom layer of the view interface sequence, which is a third layer.
204. The terminal performs a transformation processing on the view interface sequence to present a display from the initial view interface to the target view interface based on the hollow area.

The view interface sequence may be further subjected to the transformation processing so that, during the device switching, the hollow area of the black hollow mask layer may present an effect of superimposing three view interfaces, making it look like a complete interface that is being rotated, scaled, or otherwise transformed.

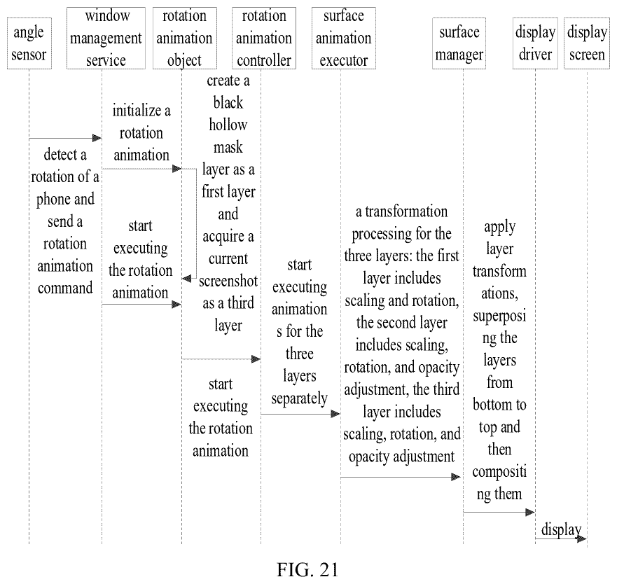

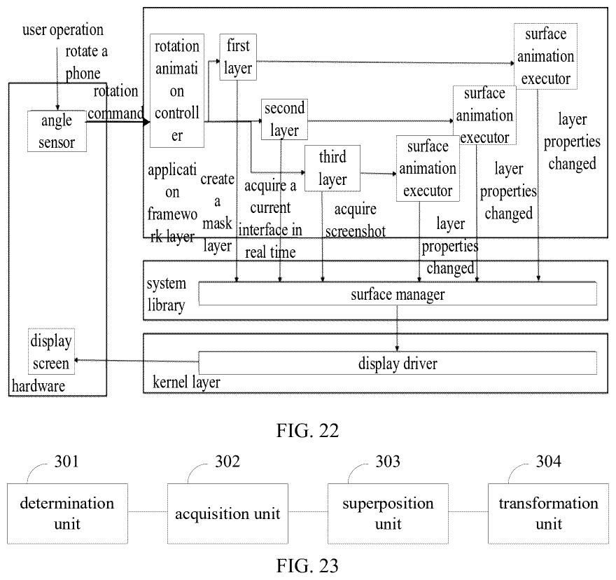

In practical applications, the display process shown in FIG. 21 and a module interaction diagram in the device shown in FIG. 22 can be referred to. Specifically, the terminal can be a mobile phone as an example, the user can rotate the mobile phone, an angle sensor of the mobile phone determines that the rotation occurs, and sends a rotation instruction to a window management service. The window management service initializes a rotation animation object, which creates and draws the mask layer as the first layer and acquires the screenshot of the interface when the screen is not rotated as the third layer. Furthermore, the window management service can send instructions to start the rotation animation: 1) a rotation animation controller first initializes three surfaceanimators (surface animation executors); 2) each surface animation executor calculates layer properties bound to the executor when drawing each frame, and sends the layer and properties to a surface manager for synthesis in each frame; 3) the surface manager collects the layers and their properties of each frame, synthesizes them for display, and finally presents them on a display screen.

Animation features of each layer of the view interface can be specifically:
An animation of the auxiliary view interface: it consists of performing a scaling transformation and a rotation transformation on the auxiliary view interface, where a principle of scaling is that: an original length becomes a width of a new state, and an original width becomes a length of the new state.
An animation of the target view interface: it consists of performing a scaling transformation, a rotation transformation, and a transparency adjustment on the target view interface, where a principle of scaling is that: a width of the target view interface is always greater than or equal to a width of the hollow area in the black hollow mask layer; and the transparency adjustment is specifically changing from 0 to 1.
An animation of the initial view interface: it consists of performing a scaling transformation, a rotation transformation, and a transparency adjustment on the initial view interface, where a principle of scaling is that: a width of the initial view interface is always greater than or equal to a width of the hollow area in the black hollow mask layer; a principle of rotation is that: a rotation angle of the initial view interface is always consistent with that of the auxiliary view interface; the transparency adjustment is specifically changing from 1 to 0.

As can be seen from the above, in the device switching process of switching from displaying the initial view interface to displaying the target view interface, the embodiment of the present application can present a dynamic transition from the initial view interface to the target view interface through the auxiliary view interface having the hollow area, so that the user can actually perceive the switch display of the view interface. In addition, since only the initial view interface, the target view interface, and the auxiliary view interface are involved in the device switching process, the embodiment of the present application can avoid the time consumption and computing resource consumption caused by the large number of layers involved, thereby improving the display dynamic effect of the interface and improving the display efficiency of the interface.

In addition, since the embodiment of the present application acquires the auxiliary view interface before presenting the animation effect of the device switching by performing the transformation processing on the view interface sequence, the embodiment of the present application can pre-draw the auxiliary view interface required for the device switching before the animation of the device switching begins. This can reduce the computing burden of the system during the animation process of the device switching, thereby ensuring good drawing performance during the animation process of the device switching and avoiding problems such as drawing timeouts and animation stuttering due to too many drawing tasks, thereby further improving the display dynamic effect of the interface and improving the display efficiency of the interface.

In order to better implement the interface display method provided in the embodiments of the present application, an interface display apparatus is also provided in one embodiment, and the interface display apparatus can be integrated in a computer device, and the computer device can be a terminal or other device. The terminal can be a smart phone, a tablet computer, a laptop computer, a desktop computer, a smart speaker, a smart watch, a car computer, etc., but is not limited thereto. The terminal and the server can be directly or indirectly connected via wired or wireless communication, and the present application does not limit this. The meanings of the relevant terms are the same as those in the above-mentioned interface display method, and the specific implementation details can refer to the description in the method embodiment.

In one embodiment, an interface display apparatus is provided. The interface display apparatus may be integrated in a computer device. As shown in FIG. 23, the interface display apparatus may include a determination unit 301, an acquisition unit 302, a superposition unit 303, and a transformation unit 304, as follows:

The determination unit 301 is configured to determine a target view interface indicated by a display switching instruction in response to the display switching instruction for a currently displayed initial view interface.

The acquisition unit 302 is configured to acquire an auxiliary view interface displayed on an interface, where the auxiliary view interface includes a hollow area.

The superposition unit 303 is configured to perform a superposition processing on the initial view interface, the target view interface, and the auxiliary view interface to obtain a view interface sequence in which the auxiliary view interface is placed on an upper layer.

The transformation unit 304 is configured to perform a transformation processing on the view interface sequence to present a display from the initial view interface to the target view interface based on the hollow area.

In one embodiment, the determination unit 301 may include:
an orientation determination subunit configured to determine a target interface orientation indicated by a screen switching instruction if the screen switching instruction is detected during a process of displaying the initial view interface corresponding to an initial interface orientation.
an interface determination subunit configured to determine the target view interface indicated by the display switching instruction according to the initial view interface and the target interface orientation.

In one embodiment, the acquisition unit 302 may include:
an area information determination subunit configured to determine area size information and area arrangement information of the hollow area, where the area arrangement information is configured to describe an area arrangement of the hollow area in the auxiliary view interface.
an area division subunit configured to divide the hollow area in a view interface of a target size according to the area size information and the area arrangement information.
an interface drawing subunit configured to draw the divided view interface to acquire the auxiliary view interface displayed on the interface.

In one embodiment, the area division subunit is configured to:
determine a target distance feature of the hollow area according to a target interface orientation indicated by the display switching instruction, where the target distance feature represents a distance between the hollow area and a terminal display area; analyze the target distance feature to determine a target size of the view interface of the hollow area to be divided; divide the hollow area in the view interface corresponding to the target size according to the area size information and the area arrangement information.

In one embodiment, the interface drawing subunit is configured to:
determine a mask area in the view interface of the target size according to a division result; determine drawing parameter information of the mask area; draw the divided view interface according to the drawing parameter information.

In one embodiment, the superposition unit 303 may include:
an area determination subunit configured to respectively determine target focus areas of the initial view interface, the target view interface, and the auxiliary view interface.
a superposition processing subunit configured to perform the superposition processing on the initial view interface, the target view interface, and the auxiliary view interface according to the determined target focus areas.

In one embodiment, the target view interface includes at least one interface element; the area determination subunit is configured to:
determine a focused target interface element from interface elements of the target view interface; determine the target focus area of the target view interface according to element arrangement information of the target interface element in the target view interface.

In one embodiment, the transformation unit 304 may include:
an interface information determination subunit configured to determine size adjustment information of a view interface in the view interface sequence.
a size adjustment subunit configured to perform a size adjustment transformation processing on the view interface in the view interface sequence according to the size adjustment information to present a size adjustment of a view interface under the auxiliary view interface during a display process from the initial view interface to the target view interface based on the hollow area of the auxiliary view interface.

In one embodiment, the size adjustment information indicates that the size adjustment is achieved by performing a scaling transformation on the view interface under the auxiliary view interface; the size adjustment subunit is configured to:
acquire area size information of the hollow area of the auxiliary view interface; determine a scaling threshold for the view interface under the auxiliary view interface according to the area size information; perform the size adjustment transformation processing on the view interface under the auxiliary view interface in the view interface sequence based on the size adjustment information and the scaling threshold.

In one embodiment, the view interface under the auxiliary view interface in the view interface sequence includes at least one interface element; the size adjustment subunit is specifically configured to:
determine a focused target interface element of a scaling transformation processing from interface elements of the view interface; determine a scaling center area of performing the scaling transformation on the view interface according to element arrangement information of the target interface element in the view interface; perform the scaling transformation processing on the view interface based on the scaling center area.

In one embodiment, the view interface sequence includes the auxiliary view interface, and the size adjustment information indicates that the size adjustment is achieved by performing a shape transformation on the auxiliary view interface; the size adjustment subunit is configured to:
analyze the size adjustment information to obtain an initial shape and a target shape of the auxiliary view interface; in the display process from the initial view interface to the target view interface, acquire current display progress information, and transform the auxiliary view interface from the initial shape to the target shape according to the display progress information, so as to perform a shape transformation processing on the auxiliary view interface.

In one embodiment, the transformation unit 304 may include:
an orientation determination subunit configured to determine a rotation orientation of each view interface in the view interface sequence according to a target interface orientation indicated by the display switching instruction.
a rotation transformation subunit configured to perform a rotation transformation processing on each view interface in the view interface sequence according to the rotation orientation to present a rotation transformation of a view interface under the auxiliary view interface in a display process from the initial view interface to the target view interface based on the hollow area of the auxiliary view interface.

In one embodiment, the transformation unit 304 may include:
a property adjustment subunit configured to acquire current display progress information in a display process from the initial view interface to the target view interface, and adjust an interface property of a view interface in the view interface sequence according to the display progress information, so as to perform the transformation processing on the view interface sequence.

In specific implementation, the above units can be implemented as independent entities, or can be arbitrarily combined to be implemented as the same or several entities. The specific implementation of the above units can refer to the previous method embodiments, which will not be repeated here.

As can be seen from the above, in the interface display apparatus of this embodiment, the determination unit 301 determines the target view interface indicated by the display switching instruction in response to the display switching instruction for the currently displayed initial view interface; the acquisition unit 302 acquires the auxiliary view interface displayed on the interface, and the auxiliary view interface includes the hollow area; the superposition unit 303 performs the superposition processing on the initial view interface, the target view interface, and the auxiliary view interface to obtain the view interface sequence in which the auxiliary view interface is placed on the upper layer; and the transformation unit 304 performs the transformation processing on the view interface sequence to present the display from the initial view interface to the target view interface based on the hollow area.

This solution can, during a device switching process from displaying the initial view interface to displaying the target view interface, present a dynamic transition from the initial view interface to the target view interface through the auxiliary view interface with the hollow area, allowing the user to truly perceive the switch display of the view interface. Furthermore, since the device switching process only involves the initial view interface, the target view interface, and the auxiliary view interface, this solution can avoid the time consumption and computational resource consumption caused by the larger number of layers involved, thereby improving the dynamic display effect of the interface and enhancing the display efficiency. Additionally, because the solution acquires the auxiliary view interface before performing transformation processing on the view interface sequence to present an animation effect of the device switching, it allows the solution to pre-draw the auxiliary view interface required for the device switching before the animation of the device switching starts. This can reduce a system's computational burden during the animation process of the device switching, ensuring good drawing performance during the animation process of the device switching and avoiding issues such as drawing timeouts and animation stuttering caused by excessive drawing tasks, thus further improving the dynamic display effect of the interface and enhancing the display efficiency of the interface.

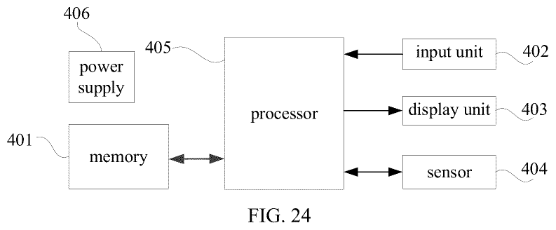

In addition, an embodiment of the present application also provides a computer device, which may be a terminal. As shown in FIG. 24, it shows a schematic diagram of a structure of a computer device involved in an embodiment of the present application. Specifically:

The computer device may include a memory 401 including one or more computer-readable storage mediums, an input unit 402, a display unit 403, a sensor 404, a processor 405 including one or more processing cores, and a power supply 406. Those skilled in the art will appreciate that the structure of the computer device shown in FIG. 24 does not limit the computer device, and may include more or fewer components than shown in the figure, or combine certain components, or arrange the components differently.

The memory 401 can be configured to store software programs and modules. The processor 405 executes various functional applications and data processing by running the software programs and modules stored in the memory 401. The memory 401 may mainly include a program storage area and a data storage area, where the program storage area may store an operating system, an application required for at least one function (such as a sound playback function, an image playback function, etc.), etc.; the data storage area may store data created according to the use of the computer device, etc. In addition, the memory 401 may include a high-speed random access memory, and may also include a non-volatile memory, such as at least one disk storage device, a flash memory device, or other volatile solid-state storage devices. Accordingly, the memory 401 may also include a memory controller to provide the processor 405 and the input unit 402 with access to the memory 401.

The input unit 402 can be configured to receive input number or character information and to generate keyboard, mouse, joystick, optical or trajectory ball signal inputs related to a user's setting and functional control. In detail, in a specific embodiment, the input unit 402 can include a touch-sensitive surface and other input devices. The touch-sensitive surface, also called a touch display screen or a touch panel, can be configured to detect touch operations of a user on or near the touch-sensitive surface (for example, operations carried out by the user through any suitable objects or attachments, such as a finger, a touch pen and the like, on the touch-sensitive surface or near the touch-sensitive surface) and to drive a corresponding device connected therewith according to a preset program. Optionally, the touch-sensitive surface can include a touch detection device and a touch controller. The touch detection device detects the touch direction of the user, detects a signal caused by the touch operation, and transmits the signal to the touch controller. The touch controller receives touch information from the touch detection device, converts the touch information into a contact coordinate, and then transmits the contact coordinate to the processor 405 and can receive a command transmitted by the processor 405 and execute the command. Moreover, the touch-sensitive surface can be one of various types, such as a resistance type, a capacitance type, an infrared type, a surface acoustic wave type and the like. Besides the touch-sensitive surface, the input unit 402 also can include the other input devices. In detail, other input devices can include, but is not limited to, one or more of a physical keyboard, function keys (such as a volume control key, a switching key and the like), a trackball, a mouse, a joystick and the like.

The display unit 403 can be configured to display information input by the user or information provided for the user and various graphical user interfaces of the computer device. The graphical user interfaces can be constituted by graphics, texts, icons, videos and any combinations of them. The display unit 403 can include a display panel. Optionally, the display panel can be configured in forms of a Liquid Crystal Display (LCD), an Organic Light-Emitting Diode (OLED) and the like. Furthermore, the touch-sensitive surface can cover the display panel. When the touch-sensitive surface detects a touch operation on or near it, the signal caused by the touch operation is transmitted to the processor 405 to determine the type of a touch event. Then, the processor 405 provides a corresponding visual output on the display panel according to the type of the touch event. Although the touch-sensitive surface and the display panel in FIG. 24 are served as two independent parts for accomplishing input and output functions, it can be understood that the touch-sensitive surface and the display panel can be integrated to accomplish the input and output functions.

The computer device can further include at least one sensor 404, such as an optical sensor, a motion sensor and other sensors. In detail, the optical sensor can include an environmental light sensor and a proximity sensor. The environmental light sensor can adjust brightness of the display panel according to the lightness of environmental light. The proximity sensor may turn off the display panel and/or the backlight when the computer device is moved to the car. As one type of the motion sensor, an accelerometer sensor can detect the value of an acceleration in each direction (generally in three axial directions), can detect the value and the direction of gravity in a static state, which can be used for applications that recognize the posture of a phone (such as switching between a landscape screen and a portrait screen, switching related to a game, and calibration on the posture of a magnetometer), vibration identifying functions (such as for pedometer and striking) and the like. Furthermore, a gyroscope, a barometer, a humidity meter, a thermometer, an infrared sensor and other sensors can be integrated into the computer device, and explanations are not repeated herein.

The processor 405 is a control center of the computer device, is connected with all the parts of the whole phone by various interfaces and lines, and is configured to execute various functions of the computer device and process the data by operating or executing software programs and/or modules stored in the memory 401 and calling data stored in the memory 401, so as to carry out integral monitoring on the phone. Optionally, the processor 405 can include one or more processing cores. Preferably, the processor 405 can be integrated with an application processor and a modulation/demodulation processor. The application processor is mainly configured to process an operating system, a user interface, an application program and the like. The modulation/demodulation processor is mainly configured to process wireless communication. It can be understood that the modulation/demodulation processor can also be not integrated into the processor 405.

The computer device further includes a power supply 406 (such as a battery) for supplying power to each part. Preferably, the power supply can be logically connected with the processor 405 by a power supply management system, so as to implement functions of charge management, discharge management, power consumption management and the like by the power supply management system. The power supply 406 can further include one or more direct current or alternating current power supplies, recharging systems, power supply failure detection circuits, power converters or inverters, power supply status indicators and the like.

Although not shown, the computer device can further include a camera, a BLUETOOTH module, and the like which are not further described herein. In the present embodiment, the processor 405 in the computer device will load the executable files corresponding to the processes of one or more application programs into the memory 401 according to the following instructions, and the processor 405 will run the application programs stored in the memory 401 to implement various functions, as follows:

in response to a display switching instruction for a currently displayed initial view interface, determining a target view interface indicated by the display switching instruction; acquiring an auxiliary view interface displayed on an interface, where the auxiliary view interface includes a hollow area; performing a superposition processing on the initial view interface, the target view interface, and the auxiliary view interface to obtain a view interface sequence in which the auxiliary view interface is placed on an upper layer; performing a transformation processing on the view interface sequence to present a display from the initial view interface to the target view interface based on the hollow area.

The specific implementation of the above operations can be found in the previous embodiments, which will not be described in detail here.

As can be seen from the above, the computer device of this embodiment can, during a device switching process from displaying the initial view interface to displaying the target view interface, present a dynamic transition from the initial view interface to the target view interface through the auxiliary view interface with the hollow area, allowing the user to truly perceive the switch display of the view interface. Furthermore, since the device switching process only involves the initial view interface, the target view interface, and the auxiliary view interface, the computer device can avoid the time consumption and computational resource consumption caused by the larger number of layers involved, thereby improving the dynamic display effect of the interface and enhancing the display efficiency. Additionally, because the computer device acquires the auxiliary view interface before performing transformation processing on the view interface sequence to present an animation effect of the device switching, it allows the computer device to pre-draw the auxiliary view interface required for the device switching before the animation of the device switching starts. This can reduce a system's computational burden during the animation process of the device switching, ensuring good drawing performance during the animation process of the device switching and avoiding issues such as drawing timeouts and animation stuttering caused by excessive drawing tasks, thus further improving the dynamic display effect of the interface and enhancing the display efficiency of the interface.

Those skilled in the art will appreciate that all or part of the steps in the various methods of the above embodiments may be completed by a computer program, or by controlling related hardware through a computer program. The computer program may be stored in a computer-readable storage medium and loaded and executed by a processor.

To this end, an embodiment of the present application further provides a computer-readable storage medium, in which a computer program is stored, and the computer program can be loaded by a processor to execute the steps in any interface display method provided in the embodiments of the present application. For example, the computer program can execute the following steps:
in response to a display switching instruction for a currently displayed initial view interface, determining a target view interface indicated by the display switching instruction; acquiring an auxiliary view interface displayed on an interface, where the auxiliary view interface includes a hollow area; performing a superposition processing on the initial view interface, the target view interface, and the auxiliary view interface to obtain a view interface sequence in which the auxiliary view interface is placed on an upper layer; performing a transformation processing on the view interface sequence to present a display from the initial view interface to the target view interface based on the hollow area.

The specific implementation of each of the above operations can be found in the previous embodiments, which will not be repeated here.

The computer-readable storage medium may include: a read-only memory (ROM), a random access memory (RAM), a disk or an optical disk, etc.

Due to instructions stored in the computer-readable storage medium, the steps in any interface display method provided in the embodiments of the present application can be executed. Therefore, beneficial effects that can be achieved by any interface display method provided in the embodiments of the present application can be achieved, as detailed in the previous embodiments, which will not be repeated here.

According to one aspect of the present application, a computer program product or a computer program is provided. The computer program product or the computer program includes computer instructions. The computer instructions are stored in a computer-readable storage medium. A processor of a computer device reads the computer instructions from the computer-readable storage medium, and the processor executes the computer instructions, so that the computer device is enabled to execute the methods provided in various optional implementations of the above-mentioned interface display aspects.

The interface display method and apparatus, the computer device, and the storage medium provided in the embodiments of the present application are described in detail above. Specific examples are used in this specification to illustrate the principles and implementation methods of the present application. The description of the above embodiments is only configured to help understand the method and core idea of the present application; at the same time, for those skilled in the art, according to the idea of the present application, there will be changes in the specific implementation method and application scope. In summary, the content of this specification should not be understood as a limitation on the present application.

1. An interface display method, comprising:
in response to a display switching instruction for a currently displayed initial view interface, determining a target view interface indicated by the display switching instruction;
acquiring an auxiliary view interface displayed on an interface, wherein the auxiliary view interface comprises a hollow area;
performing a superposition processing on the initial view interface, the target view interface, and the auxiliary view interface to obtain a view interface sequence in which the auxiliary view interface is placed on an upper layer;
performing a transformation processing on the view interface sequence to present a display from the initial view interface to the target view interface based on the hollow area.

2. The interface display method according to claim 1, wherein the determining the target view interface indicated by the display switching instruction in response to the display switching instruction for the currently displayed initial view interface comprises:
during a process of displaying the initial view interface corresponding to an initial interface orientation, if a screen switching instruction is detected, determining a target interface orientation indicated by the screen switching instruction;
determining the target view interface indicated by the display switching instruction according to the initial view interface and the target interface orientation.

3. The interface display method according to claim 1, wherein the acquiring the auxiliary view interface displayed on the interface in which the auxiliary view interface comprises the hollow area comprises:
determining area size information and area arrangement information of the hollow area, wherein the area arrangement information is configured to describe an area arrangement of the hollow area in the auxiliary view interface;
dividing the hollow area in a view interface of a target size according to the area size information and the area arrangement information;
drawing the divided view interface to acquire the auxiliary view interface displayed on the interface.

4. The interface display method according to claim 3, wherein the dividing the hollow area in the view interface of the target size according to the area size information and the area arrangement information comprises:
determining a target distance feature of the hollow area according to a target interface orientation indicated by the display switching instruction, wherein the target distance feature represents a distance between the hollow area and a terminal display area;
analyzing the target distance feature to determine a target size of the view interface of the hollow area to be divided;
dividing the hollow area in the view interface corresponding to the target size according to the area size information and the area arrangement information.

5. The interface display method according to claim 3, wherein the drawing the divided view interface comprises:
determining a mask area in the view interface of the target size according to a division result;
determining drawing parameter information of the mask area;
drawing the divided view interface according to the drawing parameter information.

6. The interface display method according to claim 1, wherein the performing the superposition processing on the initial view interface, the target view interface, and the auxiliary view interface comprising:
respectively determining target focus areas of the initial view interface, the target view interface, and the auxiliary view interface;
performing the superposition processing on the initial view interface, the target view interface, and the auxiliary view interface according to the determined target focus areas.

7. The interface display method according to claim 6, wherein the target view interface comprises at least one interface element;
the determining the target focus area of the target view interface comprises:
determining a focused target interface element from interface elements of the target view interface;
determining the target focus area of the target view interface according to element arrangement information of the target interface element in the target view interface.

8. The interface display method according to claim 1, wherein the performing the transformation processing on the view interface sequence to present the display from the initial view interface to the target view interface based on the hollow area comprises:
determining size adjustment information of a view interface in the view interface sequence;
performing a size adjustment transformation processing on the view interface in the view interface sequence according to the size adjustment information to present a size adjustment of a view interface under the auxiliary view interface during a display process from the initial view interface to the target view interface based on the hollow area of the auxiliary view interface.

9. The interface display method according to claim 8, wherein the size adjustment information indicates that the size adjustment is achieved by performing a scaling transformation on the view interface under the auxiliary view interface;
the performing the size adjustment transformation processing on the view interface in the view interface sequence according to the size adjustment information comprises:
acquiring area size information of the hollow area of the auxiliary view interface;
determining a scaling threshold for the view interface under the auxiliary view interface according to the area size information;
performing the size adjustment transformation processing on the view interface under the auxiliary view interface in the view interface sequence based on the size adjustment information and the scaling threshold.

10. The interface display method according to claim 9, wherein the view interface under the auxiliary view interface in the view interface sequence comprises at least one interface element;
the performing the size adjustment transformation processing on the view interface under the auxiliary view interface in the view interface sequence comprises:
determining a focused target interface element of a scaling transformation processing from interface elements of the view interface;
determining a scaling center area of performing the scaling transformation on the view interface according to element arrangement information of the target interface element in the view interface;
performing the scaling transformation processing on the view interface based on the scaling center area.

11. The interface display method according to claim 8, wherein the view interface sequence comprises the auxiliary view interface, and the size adjustment information indicates that the size adjustment is achieved by performing a shape transformation on the auxiliary view interface;
the performing the size adjustment transformation processing on the view interface in the view interface sequence according to the size adjustment information comprises:
analyzing the size adjustment information to obtain an initial shape and a target shape of the auxiliary view interface;
in the display process from the initial view interface to the target view interface, acquiring current display progress information, and according to the display progress information, transforming the auxiliary view interface from the initial shape to the target shape, so as to perform a shape transformation processing on the auxiliary view interface.

12. The interface display method according to claim 1, wherein the performing the transformation processing on the view interface sequence to present the display from the initial view interface to the target view interface based on the hollow area comprises:
determining a rotation orientation of each view interface in the view interface sequence according to a target interface orientation indicated by the display switching instruction;
performing a rotation transformation processing on each view interface in the view interface sequence according to the rotation orientation to present a rotation transformation of a view interface under the auxiliary view interface in a display process from the initial view interface to the target view interface based on the hollow area of the auxiliary view interface.

13. The interface display method according to claim 1, wherein the performing the transformation processing on the view interface sequence comprises:
in a display process from the initial view interface to the target view interface, acquiring current display progress information, and adjusting an interface property of a view interface in the view interface sequence according to the display progress information, so as to perform the transformation processing on the view interface sequence.

14. The interface display method according to claim 3, wherein the determining the area size information and the area arrangement information of the hollow area comprises:
acquiring interface setting information of the auxiliary view interface;
extracting the area size information and the area arrangement information of the hollow area from the interface setting information of the auxiliary view interface.

15. The interface display method according to claim 7, wherein the performing the superposition processing on the initial view interface, the target view interface, and the auxiliary view interface according to the determined target focus areas comprises:
superimposing the initial view interface, the target view interface, and the auxiliary view interface from bottom to top, or superimposing the target view interface, the initial view interface, and the auxiliary view interface from bottom to top, wherein the target focus area is placed below the hollow area in the auxiliary view interface.

16. The interface display method according to claim 7, wherein the determining the target focus area of the target view interface according to the element arrangement information of the target interface element in the target view interface comprises:
using an area in the target view interface that has the same size information and position information as the target interface element as the target focus area; or
using a preset size area in the target view interface that comprises the target interface element as the target focus area.

17. The interface display method according to claim 7, wherein the determining the focused target interface element from the interface elements of the target view interface comprises:
determining the focused target interface element from the interface elements of the target view interface according to a type of the target view interface; or
determining an interface element with a highest priority among the interface elements of the target view interface as the target interface element.

18. An interface display apparatus, comprising:
a determination unit configured to determine a target view interface indicated by a display switching instruction in response to the display switching instruction for a currently displayed initial view interface;
an acquisition unit configured to acquire an auxiliary view interface displayed on an interface, wherein the auxiliary view interface comprises a hollow area;
a superposition unit configured to perform a superposition processing on the initial view interface, the target view interface, and the auxiliary view interface to obtain a view interface sequence in which the auxiliary view interface is placed on an upper layer;
a transformation unit configured to perform a transformation processing on the view interface sequence to present a display from the initial view interface to the target view interface based on the hollow area.

19-20. (canceled)

21. The interface display apparatus according to claim 18, wherein the determination unit includes:
an orientation determination subunit configured to determine a target interface orientation indicated by a screen switching instruction if the screen switching instruction is detected during a process of displaying the initial view interface corresponding to an initial interface orientation;
an interface determination subunit configured to determine the target view interface indicated by the display switching instruction according to the initial view interface and the target interface orientation.

22. The interface display apparatus according to claim 18, wherein the acquisition unit includes:
an area information determination subunit configured to determine area size information and area arrangement information of the hollow area, wherein the area arrangement information is configured to describe an area arrangement of the hollow area in the auxiliary view interface;
an area division subunit configured to divide the hollow area in a view interface of a target size according to the area size information and the area arrangement information;
an interface drawing subunit configured to draw the divided view interface to acquire the auxiliary view interface displayed on the interface.
